(19) United States
(12) Patent Application Publication
(10) Pub. No.: US 2010/0315403 A1
(43) Pub. Date: Dec. 16, 2010

(54) DISPLAY DEVICE, METHOD FOR DRIVING THE DISPLAY DEVICE, AND SCAN SIGNAL LINE DRIVING CIRCUIT

(76) Inventors: Shotaro Kaneyoshi, Osaka (JP); Kohji Ueno, Osaka (JP)

Correspondence Address: HARNESS, DICKEY & PIERCE, P.L.C., P.O. BOX 8910, RESTON, VA, 20195, US

(21) Appl. No.: 12/735,769

(22) PCT Filed: Dec. 2, 2008
(86) PCT No.: PCT/JP2008/071887

§ 371 Date: Aug. 16, 2010

(30) Foreign Application Priority Data
Feb. 19, 2008 (JP) 2008-037626

(51) Int. Cl. G06F 3/038

(52) U.S. Cl. 345/211

(57) ABSTRACT

A scan signal line driving circuit of at least one embodiment includes a plurality of stages which are aligned in a scanning direction, the scan signal line driving circuit receiving a first clock signal, a second clock signal, and a third clock signal, the first clock signal, the second clock signal, and the third clock signal being such that (i) a clock pulse of the third clock signal is followed by a clock pulse of the first clock signal, (ii) the clock pulse of the first clock signal is followed by a clock pulse of the second clock signal, and (iii) the clock pulse of the second clock signal is followed by the clock pulse of the third clock signal, the scan signal line driving circuit receiving a shift pulse at one endmost stage thereof and shifting the shift pulse from the one endmost stage thereof to the other endmost stage thereof stage by stage in accordance with each of clock pulses of the first clock signal, the second clock signal, and the third clock signal, sequentially received by the scan signal line driving circuit, each of the plurality of stages supplying a scan pulse to a corresponding one of a plurality of scan signal lines in accordance with the shift pulse inputted to that stage by the shifting. This realizes a display device which can pre-charge a target pixel with an electric potential which is close to that of a data signal for charging the target pixel, in a panel in which a plurality of first color pixels, a plurality of second color pixels, a plurality of third color pixels are arranged so as to alternate with one another along a direction in which a plurality of data signal lines extend.

### TECHNICAL FIELD

The present invention relates to pre-charging with respect to each of a plurality of pixels of a display device, which pre-charging is carried out before each of the plurality of pixels of the display device is charged with a data signal.

### BACKGROUND ART

Liquid crystal display devices are having higher definition. Such a high definition liquid crystal display device can be exemplified by, for example, a WVGA module (800RGB×480) illustrated in (a) of FIG. 19. The module has an arrangement in which pixels having the same color (red (R) pixels, green (G) pixels, blue (B) pixels) are arranged along a direction in which a plurality of source lines extend. For this reason, the module includes three source drivers corresponding to the respective three colors R, G, and B. Each of the source drivers has 800 source outputs, so that a total number of source outputs of the module is 2400. Further, the module includes a gate driver which has 480 gate outputs. Meanwhile, there has been proposed another liquid crystal display device illustrated in (b) of FIG. 19. Although the liquid crystal display devices illustrated in (a) and (b) of FIG. 19 have the same resolution, the arrangement of (b) of FIG. 19 has three times the number of gate outputs (i.e. 480×3) and one-third the number of source drivers (i.e. one source driver), as compared with the arrangement of (a) of FIG. 19. This is because the liquid crystal display device illustrated in (b) of FIG. 19 has an arrangement in which the pixels having the same color (R pixels, G pixels, B pixels) are arranged along a direction in which a plurality of gate lines extend.

Either the arrangement of (a) of FIG. 19 or the arrangement of (b) of FIG. 19 employs a gate driver that is monolithically formed in a panel. Such an integral structure is called “monolithic gate driver”. The gate driver thus monolithically formed in the panel receives a signal via a flexible printed circuit (FPC) board on which the source driver is provided. As described above, the arrangement of (b) of FIG. 19 has the three times the number of gate outputs as compared with the number of those of the arrangement of (a) of FIG. 19. However, due to the fact that the gate driver is monolithically formed in the panel, (i) it is unnecessary to externally provide the gate driver, and (ii) it is possible to form the gate driver and a display region at the same time. Further, as compared with the arrangement of (a) of FIG. 19, the arrangement of (b) of FIG. 19 has one-third the number of source outputs, i.e. one-third the number of source drivers. For the reasons described above, the arrangement of (b) of FIG. 19 greatly contributes to a reduction in cost. In addition, the reduction in the number of source drivers results in a reduction in an area of the FPC. This can realize a reduction in cost concerning the FPC, so that it becomes possible to further reduce the cost of the device as a whole.

FIG. 20 illustrates an arrangement of a gate driver 101 which exemplifies a first gate driver employed either with the panel of (a) of FIG. 19 or with the panel of (b) of FIG. 19.

The gate driver 101 is provided in a region adjoining a display region 102 at one lateral side of the display region 102 and includes a shift register in which a plurality of shift register stages sr (sr0, sr 1, sr2 . . . ) are connected in cascade. Each of the plurality of shift register stages sr includes: a set input terminal Qn−; an output terminal Gout; a reset input terminal Qn+; clock input terminals cka and ckb; and a clear terminal clr.

The ith (i=0, 1, 2 . . . ) shift register stage sri supplies, via its output terminal Gout, a gate output Gi to the ith gate line.

The first shift register stage sr0 receives a gate start pulse GSP via its set input terminal Qn−, while each subsequent ith shift register stage sri (sr1, sr2 . . . ) receives a gate output Gi−1 from a preceding shift register stage sri−1. Further, each ith shift register stage sri receives, via its reset input terminal Qn+, a gate output Gi+1 from a subsequent shift register stage sri+1.

Each of the plurality of shift register stages sr receives one of clock signals CKA and CKB via its clock input terminal cka, while receiving the other one of clock signals CKA and CKB via its clock input terminal ckb. Between neighboring shift register stages sr, which one of clock input terminals cka and ckb receives the clock signal CKA or the clock signal CKB is alternated. Here, the ith (i is an even number, i.e. i=0, 2, 4 . . . ) shift register stage sri receives the clock signal CKA via its clock input terminal cka, while receiving the clock signal CKB via its clock input terminal ckb. In contrast, the ith (i is an odd number, i.e. i=1, 3, 5 . . . ) shift register stage sri receives the clock signal CKB via its clock input terminal cka, while receiving the clock signal CKA via its clock input terminal ckb. Phases of the clock signals CKA and CKB are mutually complementary to each other, e.g. they are opposite to each other (see FIG. 22). Each of the plurality of shift register stages sr receives, via its clear terminal clr, a clear signal CLR by which the entire shift register is initialized.

According to the gate driver 101 of FIG. 20, the gate output Gi is sequentially outputted during clock pulse periods of the respective clock signals CKA and CKB, which clock pulse periods alternate with each other (see FIG. 22).

FIG. 21 illustrates an arrangement of a gate driver 201 which exemplifies a second gate driver employed either with the panel of (a) of FIG. 19 or with the panel of (b) of FIG. 19.

The gate driver 201 is constituted by a gate driver 201a and a gate driver 201b. The gate drivers 201a and 201b are provided so as to face each other via a display region 202 therebetween. The gate driver 201a generates a gate output Gi which is received by the ith (i is an even number, i.e. i=0, 2, 4 . . . ) gate line, while the gate driver 201b generates a gate output Gi which is received by the ith (i is an odd number, i.e. i=1, 3, 5 . . . ) gate line.

The gate driver 201a includes a shift register in which a plurality of shift register stages sr (sr0, sr2, sr4 . . . ) are provided such that neighboring shift register stages sr are connected to each other. Each of the plurality of shift register stages sr includes: a set input terminal Qn−; an output terminal Gout; a reset input terminal Qn+, clock input terminals cka and ckb; and a clear terminal clr.

In the following example, the gate driver 201a receives a gate start pulse GSP1, while the gate driver 201b receives a gate start pulse GSP2 which is different from the gate start pulse GSP1. Note, however, that basically, these gate start pulses can be identical with each other.

The first shift register stage sr0 receives the gate start pulse GSP1 via its set input terminal Qn−, while each subsequent ith shift register stage sri (sr2, sr4 . . . ) receives a gate output Gi−2 from a preceding shift register stage sri−2. Further, each ith shift register stage sri receives, via its reset input terminal Qn+, a gate output Gi+2 from a subsequent shift register stage sri+2.

Each of the plurality of shift register stages sr receives one of the clock signals CKA and CKB via its clock input terminal cka, while receiving the other one of the clock signals CKA and CKB via its clock input terminal ckb. Between neighboring shift register stages sr, which one of the clock input terminals cka and ckb receives the clock signal CKA or the clock signal CKB is alternated. Here, the ith (i=0, 4, 8 . . . ) shift register stage sri receives the clock signal CKA via its clock input terminal cka, while receiving the clock signal CKB via its clock input terminal ckb. In contrast, the ith (i=2, 6, 10 . . . ) shift register stage sri receives the clock signal CKB via its clock input terminal cka, while receiving the clock signal CKA via its clock input terminal ckb. Phases of the clock signals CKA and CKB are mutually complementary to each other (see FIG. 23). Each of the plurality of shift register stages sr receives, via its clear terminal clr, a clear signal CLR by which the entire shift register is initialized.

The gate driver 201b includes a shift register in which a plurality of shift register stages sr (sr1, sr3, sr5 . . . ) are provided such that neighboring shift register stages sr are connected to each other. Each of the plurality of shift register stages sr includes: a set input terminal Qn−; an output terminal Gout; a reset input terminal Qn+; clock input terminals cka and ckb; and a clear terminal clr.

The first shift register stage sr1 receives the gate start pulse GSP2 via its set input terminal Qn−, while each subsequent ith shift register stage sri (sr3, sr5 . . . ) receives a gate output Gi−2 from a preceding shift register stage sri−2. Further, each ith shift register stage sri receives, via its reset input terminal Qn+, a gate output Gi+2 from a subsequent shift register stage sri+2.

Each of the shift register stages sr receives one of the clock signals CKC and CKD via its clock input terminal cka, while receiving the other one of clock signals CKC and CKD via its clock input terminal ckb. Between neighboring shift register stages sr, which one of the clock input terminals cka and ckb receives the clock signal CKC or the clock signal CKD is alternated. Here, the ith (i=1, 5, 9 . . . ) shift register stage sri receives the clock signal CKC via its clock input terminal cka, while receiving the clock signal CKD via its clock input terminal ckb. In contrast, the ith (i=3, 7, 11 . . . ) shift register stage sri receives the clock signal CKD via its clock input terminal cka, while receiving the clock signal CKC via its input terminal ckb. Phases of the clock signals CKC and CKD are mutually complementary to each other (see FIG. 23). Further, clock pulse periods of the respective clock signals CKA, CKB, CKC, and CKD do not overlap with one another. The clock pulse period switches over in the order of (1) CKA, (2) CKC, (3) CKB, (4) CKD. After the clock pulse period of the clock pulse CKD, the clock pulse period switches over to the clock pulse period of the clock pulse signal CKA, and then this cycle is repeated. Each of the shift register stages sr receives the clear signal CLR via its clear terminal clr.

According to the gate driver 201 of FIG. 21, the gate output Gi is sequentially outputted during the clock pulse periods of the respective clock pulse signals CKA through CKD, which clock pulse periods alternate with one another (see FIG. 23).

The gate driver 101 described above is driven by so-called bi-phase clock signals, i.e. two clock signals which are mutually complementary to each other. Further, each of the gate derivers 201a and 201b of the gate driver 201 described above is also driven by such bi-phase clock signals.

The following description deals with an arrangement of a shift register stage sr employed either in the gate driver 101 of FIG. 20 or in the gate driver 201 of FIG. 21.

FIG. 24 illustrates an arrangement of a shift register stage 221 (corresponding to the jth row in FIG. 24) which is described in Patent Literature 1. The shift register stage 221 is constituted by transistors all of which are n-channel transistors. Therefore, the shift register stage 221 can be suitably used in a gate driver monolithically formed in the panel.

Clocks φ1 and φ2, i.e. bi-phase clock signals, have waveforms whose phases are opposite to each other, respectively, that is, the waveforms are mutually complementary to each other (see FIG. 25). In a case where a drain of a transistor Tp receives, via a line 222, a pulse of a gate output from a shift register stage in the J−1 th row, the transistor Tp is turned on. Subsequently, charging is started with respect to a capacitance Cb connected between a gate and a source of the transistor T1. When a drain of the transistor T1 receives a pulse of the clock signal φp 1, a stray capacitance Cp formed between the drain of the transistor T1 and a node G generates a bootstrap effect. However, an increase in electric potential at the node G due to the stray capacitance Cp is cancelled by a capacitance C2 connected between an input terminal for receiving the clock signal φ2 and the node G, which capacitance C2 has a capacitance value equal to that of the stray capacitance Cp. When the charging of the capacitance Cb causes the transistor T1 to be turned on, an electric potential at a node D connected to the source of the transistor T1 is increased by the pulse of the clock signal φ1. It follows that the electric potential at the node G is increased due to the bootstrap effect of the capacitance Cb. This causes the transistor T1 to be rapidly reduced in resistance value, so that a pulse of the gate output of the shift register stage 221 in the jth row is supplied to the node D.

The node D is connected to one of ends of a capacitance C1 which serves as a load. The other one of ends of the capacitance C1 is connected to ground 232. When a gate of a transistor Td receives, via a line 230, a pulse of a gate output from a shift register stage in the J+1th row, the transistor Td is turned on. It follows that the electric potential at the node G is reset by a power source V−.

### CITATION LIST

Patent Literature 1

Japanese Translation of PCT International Publication, Tokuhyohei, No. 10-500243 A (1998) (Publication Date: Jan. 6, 1998)

Patent Literature 2

Japanese Patent Application Publication, Tokukaisho, No. 60-134293 A (1985) (Publication Date: Jul. 17, 1985)

### SUMMARY OF INVENTION

According to the liquid crystal display device of (b) of FIG. 19, which has the panel in which the pixels of the same color are arranged along the direction in which the plurality of gate lines extend, one horizontal period (i.e. 3, 7, 11 . . . selection period) during which a data signal can be written to a pixel is significantly short. This is because (i) the panel has high definition, and (ii) the number of the plurality of gate lines is three times more than that of the liquid crystal display device having the panel in which the pixels of the same color are arranged along the direction in which the plurality of source lines extend (like the one illustrated in (a) of FIG. 19). Accordingly, it is preferable to carry out the pre-charging with respect to each of the pixels before the data signal is written to the pixel, so that the data signal would be sufficiently written to the pixel.

It is possible to employ a method of FIG. 26, as a method for pre-charging each of the pixels, for example.

The method of FIG. 26 is a pre-charging method described in Patent Literature 2. According to the method, in the panel in which R pixels, G pixels, B pixels are arranged so as to alternate with one another along the direction (column direction) in which the plurality of data signal lines extend, a target pixel is pre-charged with a data signal applied to another pixel having the same color as the target pixel. For example, a target R pixel is pre-charged with a data signal received by another R pixel located in the upstream of the R pixel, which another R pixel receives the data signal before the target R pixel receives its corresponding data signal.

In FIG. 26, (A) shows a scan signal supplied to the i−3th row in which the R pixels are arranged, (B) shows a scan signal supplied to the i−2th row in which the G pixels are arranged, (C) shows a scan signal supplied to the i−1 th row in which the B pixels are arranged, (D) shows a scan signal supplied to the ith row in which the R pixels are arranged, (E) shows each of RGB data signals supplied to a data signal line in the jth column, (F) shows an electric potential at a pixel in the ith row and the jth column in a case where the pre-charging is not carried out, and (G) shows an electric potential at the pixel in the ith row and the jth column in a case where the pre-charging is carried out.

As is clear from (A) through (D) of FIG. 26, the target pixels in each row are pre-charged with data signals supplied to the pixels which have the same color as the target pixels and are located three rows before the target pixels. (E) of FIG. 26 shows that an R pixel in the ith row and the jth column is pre-charged with an electric potential of a data signal Vi−3 applied to another R pixel in the 1-3th row and the jth column, and then main-charged with (written with) a data signal Vi.

As described above, according to Patent Literature 2, the target pixel is pre-charged with the data signal supplied to the pixel which has the same color as the target pixel and has a data electric potential close to that of the target pixel. Therefore, the main-charging can be started from an electric potential which is close to the target electric potential. This makes it possible to allow the data signal to be sufficiently written to the pixel (as shown in (G) of FIG. 26) by preventing the electric potential at the pixel from failing to reach the target electric potential (as shown in (F) in FIG. 26).

However, the pre-charging described above, using the data signal supplied to the pixel having the same color as the target pixel, raises the following problems in a case where such pre-charging is applied to the gate driver operated by the bi-phase clock signals (e.g. the gate drivers of FIGS. 20 and 21).

In FIGS. 22 and 23, a shift register stage supplies its gate output during a pulse period of one of the clocks of the bi-phase clock signals. For this reason, it is necessary to use, for the pre-charging, a pulse having the same timing as a gate output received by a gate line which is located away from the target gate line by 2 or more (a multiple of 2) lines, on the same data signal line. For example, in FIG. 22, the pulse having the same timing as the gate output G0 may be used as a pixel selection pulse for the pre-charging with respect to any of the gate outputs G2, G4, G6 . . . . Accordingly, in a case where the pre-charging using the data signal supplied to the pixel having the same color as the target pixel is carried out in the panel in which the R pixels, the G pixels, and the B pixels are arranged so as to alternate with one another along the direction in which the plurality of data signal lines extend, a combination of the data signals which are closest to each other in electric potential is a combination of a data signal received by the target gate line and a data signal received by a gate line located away from the target gate line by six lines. For example, in view of the aforementioned combination, the gate output G0 can be used as the pixel selection pulse for the pre-charging with respect to the gate line for receiving the gate output G6. In the case of FIG. 23, for the pre-charging, the combination of the data signals which are closest to each other in electric potential is a combination of a data signal received by the target gate line and a data signal received by a gate line located away from the target gate line by twelve lines.

FIG. 27 illustrates an example where, in the driving by the method of FIG. 22, the target pixels are pre-charged with the data signals supplied to the pixels located six lines before the target pixels, while FIG. 28 illustrates an example where, in the driving by the method of FIG. 23, the target pixels are pre-charged with the data signals supplied to the pixels located twelve lines before the target pixels. Either in FIG. 27 or 28, although data signals supplied via the same data signal line during each frame have the same polarity, only data signals supplied to pixels located far away from the target pixels are available for the pre-charging.

This problem further raises the following significant problem. There is a case where a displayed image has a large color fluctuation, such as a window pattern illustrated in FIG. 29 in which a region 252 having a certain color includes a region 251 having a color which is different from the certain color, i.e. an image called “killer pattern”. In a case where the image illustrated in FIG. 29 is subjected to the aforementioned pre-charging, a part 252a of the region 252, being in the vicinity of a boundary between the regions 252 and 251, is pre-charged with an electric potential at the region 251, which electric potential is totally different from a target electric potential of the main-charging with respect to the part 252a.

The present invention is made in view of the conventional problems. An object of the present invention is to realize: a display device; a method for driving the display device; and a scan signal line driving circuit, each of which can pre-charge a target pixel with an electric potential which is close to that of a data signal for charging the target pixel, in a panel in which a plurality of three-color pixels are arranged so as to alternate with one another along a direction in which a plurality of data signal lines extend.

In order to attain the object, an active matrix panel of the present invention includes (i) a plurality of pixels including a plurality of first color pixels, a plurality of second color pixels, and a plurality of third color pixels, and (ii) a plurality of data signal lines, each of which is connected with part of the plurality of pixels correspondingly, such that an array unit, in which one first color pixel, one second color pixel, and one third color pixel are arranged in a predetermined order along a direction in which the plurality of data signal lines extend, is repeated along each of the plurality of data signal lines; and a scan signal line driving circuit which receives a first clock signal, a second clock signal, and a third clock signal, the first clock signal, the second clock signal, and the third clock signal being such that (i) a clock pulse of the third clock signal is followed by a clock pulse of the first clock signal, (ii) the clock pulse of the first clock signal is followed by a clock pulse of the second clock signal, and (iii) the clock pulse of the second clock signal is followed by the clock pulse of the third clock signal, the scan signal line driving circuit including a shift register having a plurality of stages which are aligned in a scanning direction, the shift register receiving a shift pulse at one endmost stage thereof and shifting the shift pulse from the one endmost stage thereof to the other endmost stage thereof stage by stage in accordance with each of clock pulses of the first clock signal, the second clock signal, and the third clock signal, sequentially received by the scan signal line driving circuit, each of the plurality of stages supplying a scan pulse to a corresponding one of a plurality of scan signal lines in accordance with the shift pulse inputted to that stage by the shifting.

According to the invention, the scan signal line driving circuit includes the shift register having the plurality of stages. The shift register shifts the shift pulse stage by stage in accordance with each of the clock pulses of the first clock signal, the second clock signal, and the third clock signal, sequentially received by the scan signal line driving circuit, and each of the plurality of stages supplies a scan pulse to a corresponding one of a plurality of scan signal lines in accordance with the shift pulse inputted to that stage by the shifting. Therefore, each of the plurality of scan signal lines always receives the scan pulse in accordance with a clock pulse of a predetermined clock signal among the first, second, and third clock signals.

As described above, the clock pulses of the first, second, and third clock pulses emerge in the predetermined order. It follows that among the plurality of scan signal lines, the scan signal lines located every three lines receive the scan pulse in accordance with the clock pulse of the same clock signal.

Meanwhile, the panel has the arrangement in which the first color pixels, the second color pixels, and the third color pixels are arranged such that the array unit in which one first color pixel, one second color pixel, and one third color pixel are arranged in a predetermined order along the direction in which the plurality of data signal lines extend is repeated along the direction in which the plurality of data signal lines extend. Accordingly, in view of the pixels arranged along the same data signal line, the scan signal lines along which the pixels having the same color are arranged receive the scan pulse in accordance with the clock pulse of the same clock signal.

Therefore, by supplying, to the shift register, two (first and second) shift pulses which are away from each other by a multiple of the cycle period from the first clock signal to the third clock signal, it is possible to pre-charge the target pixel by the data signal which is supplied to main-charge, in accordance with the first shift pulse supplied before the second shift pulse, the pixel which has the same color as the target pixel. By setting the two pulses to be away from each other by a period equivalent to the cycle period, it is possible to pre-charge the target pixel by the data signal supplied to the pixel which having the same color as the target pixel and is located three lines before the target pixel. Accordingly, it becomes possible to pre-charge the target pixel with an electric potential which is closer to that of the data signal for main-charging the target pixel, as compared with the conventional technique in which the target pixel is pre-charged with the data signal supplied to the pixel which has the same color as the target pixel and is located six lines before the target pixel.

Further, in the shift register employing the tri-phase clock signals, it is possible to have a simple arrangement for generating a signal at timing of the clock pulse multiplied by any multiples of 3.

Thus, it is possible to realize a display device which can pre-charge a target pixel with an electric potential which is close to that of a data signal for charging the target signal, in a panel in which a plurality of first color pixels, a plurality of second color pixels, and a plurality of third color pixels are arranged so as to alternate with one another along a direction in which a plurality of data signal lines extend.

In order to attain the object, a display device of the present invention includes: an active matrix panel including (i) a plurality of pixels including a plurality of first color pixels, a plurality of second color pixels, and a plurality of third color pixels, and (ii) a plurality of data signal lines, each of which is connected with part of the plurality of pixels correspondingly, such that an array unit, in which one first color pixel, one second color pixel, and one third color pixel are arranged in a predetermined order along a direction in which the plurality of data signal lines extend, is repeated along each of the plurality of data signal lines; a first scan signal line driving circuit which receives a first clock signal, a second clock signal, and a third clock signal, the first scan signal line driving circuit being connected to a plurality of first scan signal lines among a plurality of scan signal lines; and a second scan signal line driving circuit which receives a fourth clock signal, a fifth clock signal, and a sixth clock signal, the second scan signal line driving circuit being connected to a plurality of second scan signal lines which are scan signal lines other than the first scan signal lines among the plurality of scan signal lines, the plurality of first scan signal lines and the plurality of second scan signal lines being arranged so as to alternate with each other, the first clock signal, the second clock signal, the third clock signal, the fourth clock signal, the fifth clock signal, and the sixth clock signal being such that (i) a clock pulse of the sixth clock signal is followed by a clock pulse of the first clock signal, (ii) the clock pulse of the first clock signal is followed by a clock pulse of the fourth clock signal, (iii) the clock pulse of the fourth clock signal is followed by a clock pulse of the second clock signal, (iv) the clock pulse of the second clock signal is followed by a clock pulse of the fifth clock signal, (v) the clock pulse of the fifth clock signal is followed by a clock pulse of the third clock signal, (iv) the clock pulse of the third clock signal is followed by the clock pulse of the sixth clock signal, the first scan signal line driving circuit including a first shift register having a plurality of stages which are aligned in a scanning direction, the first shift register receiving a first shift pulse at one endmost stage thereof and shifting the first shift pulse from the one endmost stage thereof to the other endmost stage thereof stage by stage in accordance with each of clock pulses of the first clock signal, the second clock signal, and the third clock signal, sequentially received by the first scan signal line driving circuit, each of the plurality of stages of the first shift register supplying a scan pulse to a corresponding one of the plurality of first scan signal lines in accordance with the first shift pulse inputted to that stage by the shifting, the second scan signal line driving circuit including a second shift register having a plurality of stages which are aligned in the scanning direction, the second shift register receiving a second shift pulse at one endmost stage thereof and shifting the second shift pulse from the one endmost stage thereof to the other endmost stage thereof stage by stage in accordance with each of clock pulses of the fourth clock signal, the fifth clock signal, and the sixth clock signal, sequentially received by the second scan signal line driving circuit, each of the plurality of stages of the second shift register supplying the scan pulse to a corresponding one of the plurality of second scan signal lines in accordance with the second shift pulse inputted to that stage by the shifting.

According to the invention, the first scan signal line driving circuit includes the first shift register having the plurality of stages. The first shift register shifts the first shift pulse stage by stage in accordance with each of the clock pulses of the first clock signal, the second clock signal, and the third clock signal, sequentially received by the first scan signal line driving circuit, and each of the plurality of stages supplies the scan pulse to a corresponding one of the plurality of first scan signal lines in accordance with the first shift pulse inputted to that stage by the shifting. Therefore, each of the plurality of first scan signal lines always receives the scan pulse in accordance with a clock pulse of a predetermined clock signal among the first, second, third clock signals.

As described above, the clock pulses of the first, second, and third clock pulses emerge in the predetermined order. It follows that among the plurality of first scan signal lines, the first scan signal lines located every three first scan signal lines receive the scan pulse in accordance with the clock pulse of the same clock signal.

Meanwhile, the panel has the arrangement in which the first color pixels, the second color pixels, and the third color pixels are arranged such that the array unit in which one first color pixel, one second color pixel, and one third color pixel are arranged in a predetermined order along the direction in which the plurality of data signal lines extend is repeated along the direction in which the plurality of data signal lines extend. Accordingly, in view of the pixels arranged along the same data signal line, the first scan signal lines along which the pixels having the same color are arranged receive the scan pulse in accordance with the clock pulse of the same clock signal.

On the other hand, the second scan signal line driving circuit includes the second shift register having the plurality of stages. The second shift register shifts the second shift pulse stage by stage in accordance with each of clock pulses of the fourth clock signal, the fifth clock signal, and the sixth clock signal, sequentially received by the second scan signal line driving circuit, and each of the plurality of stages supplies the scan pulse to a corresponding one of the plurality of second scan signal lines in accordance with the second shift pulse inputted to that stage by the shifting. Therefore, each of the plurality of second scan signal lines always receives the scan pulse in accordance with a clock pulse of a predetermined clock signal among the fourth, fifth, sixth clock signals.

As described above, the clock pulses of the fourth, fifth, and sixth clock pulses emerge in the predetermined order. It follows that among the plurality of second scan signal lines, the second scan signal lines located every three second scan signal lines receive the scan pulse in accordance with the clock pulse of the same clock signal.

Meanwhile, the panel has the arrangement in which the first color pixels, the second color pixels, and the third color pixels are arranged such that the array unit in which one first color pixel, one second color pixel, and one third color pixel are arranged in a predetermined order along the direction in which the plurality of data signal lines extend is repeated along the direction in which the plurality of data signal lines extend. Accordingly, in view of the pixels arranged along the same data signal line, the second scan signal lines along which the pixels having the same color are arranged receive the scan pulse in accordance with the clock pulse of the same clock signal.

Therefore, by supplying, to the first shift register, two (first and second) shift pulses which are away from each other by a multiple of the cycle period from the first clock signal to the third clock signal, it is possible to pre-charge the target pixel by the data signal which is supplied to charge, in accordance with the first shift pulse supplied before the second shift pulse, the pixel which has the same color as the target pixel, while by supplying, to the second shift register, two (first and second) shift pulses which are away from each other by a multiple of the cycle period from the fourth clock signal to the sixth clock signal, it is possible to pre-charge the target pixel by the data signal which is supplied to main-charge, in accordance with the first shift pulse supplied before the second shift pulse, the pixel which has the same color as the target pixel. By setting the two pulses to be away from each other by a period equivalent to the cycle period, it is possible to pre-charge the target pixel by the data signal supplied to the pixel which having the same color as the target pixel and is located six lines before the target pixel. Accordingly, it becomes possible to pre-charge the target pixel with an electric potential which is closer to that of the data signal for main-charging the target pixel, as compared with the conventional technique in which the target pixel is pre-charged with the data signal supplied to the pixel which has the same color as the target pixel and is located twelve lines before the target pixel.

Further, in the shift register employing the tri-phase clock signals, it is possible to have a simple arrangement for generating a signal at timing of the clock pulse multiplied by any multiples of 6.

Thus, it is possible to realize a display device which can pre-charge a target pixel with an electric potential which is close to that of a data signal for charging the target signal, in a panel in which a plurality of first color pixels, a plurality of second color pixels, and a plurality of third color pixels are arranged so as to alternate with one another along a direction in which a plurality of data signal lines extend.

In order to attain the object, in the display device of the present invention, the scan signal line driving circuit is monolithically formed in the active matrix panel.

According to the invention, in a display device employing a so-called monolithic gate driver, it is possible to pre-charge a target pixel with an electric potential which is close to that of a data signal for charging the target signal.

In order to attain the object, in the display device of the present invention, each of the first scan signal line driving circuit and the second scan signal line driving circuit is monolithically formed in the active matrix panel.

According to the invention, in a display device employing a so-called monolithic gate driver, it is possible to pre-charge a target pixel with an electric potential which is close to that of a data signal for charging the target signal.

In order to attain the object, in the display device of the present invention, in a single frame, data signals of different polarities are supplied to adjacent ones of the plurality of data signal lines, so that, among the plurality of pixels, pixels connected to one data signal line receives data signals of one polarity and pixels connected to data signal lines adjacent to the one data signal line receive data signals of the other polarity.

According to the invention, the data signals supplied to the pixels connected to the same data signal line have the same polarity. Therefore, in the above pre-charging using the data signal supplied to the pixel which has the same color as the target pixel and is located away from the target pixel by the minimum lines, it is possible to use a data signal which has the same polarity as a data signal for charging the target pixel. This pre-charging is particularly preferable.

In order to attain the object, in the display device of the present invention, the plurality of scan signal lines are independently connected with pixels of one color among the plurality of first color pixels, the plurality of second color pixels, and the plurality of third color pixels.

According to the invention, it is possible to carry out preferable pre-charging in the panel in which the plurality of scan signal lines are independently connected with the pixels of one color.

In order to attain the object, in the display device of the present invention, the plurality of scan signal lines are independently connected with pixels of different colors among the plurality of first color pixels, the plurality of second color pixels, and the plurality of third color pixels, in such a manner that pixels adjacently connected to a same scan signal line are of different colors.

According to the invention, it is possible to carry out preferable pre-charging in the panel in which the plurality of scan signal lines are independently connected with pixels of different colors in such a manner that pixels adjacently connected to a same scan signal line are of different colors.

In order to attain the object, in the display device of the present invention, the active matrix panel is formed by use of amorphous silicon.

According to the invention, it is possible to pre-charge a target pixel with an electric potential which is close to that of a data signal for charging the target pixel, in a display device formed by use of amorphous silicon.

In order to attain the object, in the display device of the present invention, the active matrix panel is formed by use of polycrystalline silicon.

According to the invention, it is possible to pre-charge a target pixel with an electric potential which is close to that of a data signal for charging the target pixel, in a display device formed by use of polycrystalline silicon.

In order to attain the object, in the display device of the present invention, the active matrix panel is formed by use of CG silicon.

According to the invention, it is possible to pre-charge a target pixel with an electric potential which is close to that of a data signal for charging the target pixel, in a display device formed by use of CG silicon.

In order to attain the object, in the display device of the present invention, the active matrix panel is formed by use of microcrystalline silicon.

According to the invention, it is possible to pre-charge a target pixel with an electric potential which is close to that of a data signal for charging the target pixel, in a display device formed by use of microcrystalline silicon.

In order to attain the object, a method of the present invention, for driving a display device, the display device including: an active matrix panel including (i) a plurality of pixels including a plurality of first color pixels, a plurality of second color pixels, and a plurality of third color pixels, and (ii) a plurality of data signal lines, each of which is connected with part of the plurality of pixels correspondingly, such that an array unit, in which one first color pixel, one second color pixel, and one third color pixel are arranged in a predetermined order along a direction in which the plurality of data signal lines extend, is repeated along each of the plurality of data signal lines; and a scan signal line driving circuit having a plurality of stages which are aligned in a scanning direction, the method includes the steps of: supplying a first clock signal, a second clock signal, and a third clock signal to the scan signal line driving circuit; and causing the scan signal line driving circuit to carry out a shift register operation, the first clock signal, the second clock signal, and the third clock signal being such that (i) a clock pulse of the third clock signal is followed by a clock pulse of the first clock signal, (ii) the clock pulse of the first clock signal is followed by a clock pulse of the second clock signal, and (iii) the clock pulse of the second clock signal is followed by the clock pulse of the third clock signal, the shift register operation including (i) receiving a shift pulse at one endmost stage of the shift register, (ii) shifting the shift pulse from the one endmost stage to the other endmost stage of the shift register stage by stage, in accordance with each of clock pulses of the first clock signal, the second clock signal, and the third clock signal, sequentially received by the scan signal line driving circuit, and (iii) causing each of the plurality of stages to supply a scan pulse to a corresponding one of a plurality of scan signal lines in accordance with the shift pulse inputted to that stage by the shifting.

Therefore, it is possible to realize a method for driving a display device, which method can pre-charge a target pixel with an electric potential which is close to that of a data signal for charging the target pixel, in a panel in which a plurality of first color pixels, a plurality of second color pixels, and a plurality of third color pixels are arranged so as to alternate with one another along a direction in which a plurality of data signal lines extend.

In order to attain the object, a method of the present invention, for driving a display device, the display device including: an active matrix panel including (i) a plurality of pixels including a plurality of first color pixels, a plurality of second color pixels, and a plurality of third color pixels, and (ii) a plurality of data signal lines, each of which is connected with part of the plurality of pixels correspondingly, such that an array unit, in which one first color pixel, one second color pixel, and one third color pixel are arranged in a predetermined order along a direction in which the plurality of data signal lines extend, is repeated along each of the plurality of data signal lines; a first scan signal line driving circuit connected to a plurality of first scan signal lines among a plurality of scan signal lines, the first scan signal line driving circuit having a plurality of stages which are aligned in a scanning direction; and a second scan signal line driving circuit connected to a plurality of second scan signal lines which are scan signal lines other than the plurality of first scan signal lines among the plurality of scan signal lines, the second scan signal line driving circuit having a plurality of stages which are aligned in the scanning direction, the plurality of first scan signal lines and the plurality of second scan signal lines being arranged so as to alternate with each other, the method includes the steps of: supplying a first clock signal, a second clock signal, and a third clock signal to the first scan signal line driving circuit; supplying a fourth clock signal, a fifth clock signal, and a sixth clock signal to the second scan signal line driving circuit; causing the first shift register to carry out a first shift register operation; and causing the second shift register to carry out a second shift register operation, the first clock signal, the second clock signal, the third clock signal, the fourth clock signal, the fifth clock signal, and the sixth clock signal being such that (i) a clock pulse of the sixth clock signal is followed by a clock pulse of the first clock signal, (ii) the clock pulse of the first clock signal is followed by a clock pulse of the fourth clock signal, (iii) the clock pulse of the fourth clock signal is followed by a clock pulse of the second clock signal, (iv) the clock pulse of the second clock signal is followed by a clock pulse of the fifth clock signal, (v) the clock pulse of the fifth clock signal is followed by a clock pulse of the third clock signal, (iv) the clock pulse of the third clock signal is followed by the clock pulse of the sixth clock signal, the first shift register operation including: (i) receiving a first shift pulse at one endmost stage of the first shift register; (ii) shifting the first shift pulse from the one endmost stage of the first shift register to the other endmost stage of the first shift register stage by stage in accordance with each of clock pulses of the first clock signal, the second clock signal, and the third clock signal, sequentially received by the first scan signal line driving circuit; and (iii) causing each of the plurality of stages of the first shift register to supply a scan pulse to a corresponding one of the plurality of first scan signal lines in accordance with the first shift pulse inputted to that stage by the shifting, the second shift register operation including: (i) receiving a second shift pulse at one endmost stage of the second shift register; (ii) shifting the second shift pulse from the one endmost stage of the second shift register to the other endmost stage of the second shift register stage by stage in accordance with each of clock pulses of the fourth clock signal, the fifth clock signal, and the sixth clock signal, sequentially received by the second scan signal line driving circuit; and (iii) causing each of the plurality of stages of the second shift register to supply a scan pulse to a corresponding one of the plurality of second scan signal lines in accordance with the second shift pulse inputted to that stage by the shifting.

Therefore, it is possible to realize a method for driving a display device, which method can pre-charge a target pixel with an electric potential which is close to that of a data signal for charging the target pixel, in a panel in which a plurality of first color pixels, a plurality of second color pixels, and a plurality of third color pixels are arranged so as to alternate with one another along a direction in which a plurality of data signal lines extend.

In order to attain the object, a scan signal line driving circuit of the present invention includes: a shift register having a plurality of stages which are aligned in a scanning direction, the scan signal line driving circuit receiving a first clock signal, a second clock signal, and a third clock signal, the first clock signal, the second clock signal, and the third clock signal being such that (i) a clock pulse of the third clock signal is followed by a clock pulse of the first clock signal, (ii) the clock pulse of the first clock signal is followed by a clock pulse of the second clock signal, and (iii) the clock pulse of the second clock signal is followed by the clock pulse of the third clock signal, the shift register receiving a shift pulse at one endmost stage thereof and shifting the shift pulse from the one endmost stage thereof to the other endmost stage thereof stage by stage in accordance with each of clock pulses of the first clock signal, the second clock signal, and the third clock signal, sequentially received by the scan signal line driving circuit, each of the plurality of stages supplying a scan pulse to a corresponding one, of a plurality of scan signal lines in accordance with the shift pulse inputted to that stage by the shifting.

Therefore, it is possible to realize a scan signal line driving circuit which can pre-charge a target pixel with an electric potential which is close to that of a data signal for charging the target pixel, in a panel in which a plurality of first color pixels, a plurality of second color pixels, and a plurality of third color pixels are arranged so as to alternate with one another along a direction in which a plurality of data signal lines extend.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a first timing chart showing an operation of a gate driver of a first liquid crystal display device in accordance with one embodiment of the present invention.

FIG. 2 is a timing chart showing an operation of a gate driver of a second liquid crystal display device in accordance with the embodiment of the present invention.

FIG. 3 is a circuit diagram illustrating an arrangement of a shift register stage.

FIG. 4 is a circuit block diagram illustrating an arrangement of the first liquid crystal display device: (a) of FIG. 4 illustrates the entire display device; and (b) of FIG. 4 illustrates the gate driver.

FIG. 5 is a circuit block diagram illustrating an arrangement of the second liquid crystal display device: (a) of FIG. 5 illustrates the entire display device; and (b) of FIG. 5 illustrates the gate driver.

FIG. 6 is a view illustrating pre-charging and main-charging with respect to pixels provided in Pattern 1.

FIG. 7 is a view illustrating the pre-charging and the main-charging with respect to pixels provided in Pattern 2.

FIG. 8 is a view illustrating the pre-charging and the main-charging with respect to pixels provided in Pattern 3.

FIG. 9 is a view illustrating the pre-charging and the main-charging with respect to pixels provided in Pattern 4.

FIG. 10 is a view illustrating the pre-charging and the main-charging with respect to pixels provided in Pattern 5.

FIG. 11 is a view illustrating the pre-charging and the main-charging with respect to pixels provided in Pattern 6.

FIG. 12 is a view illustrating the pre-charging and the main-charging with respect to pixels provided in Pattern 7.

FIG. 13 is a view illustrating the pre-charging and the main-charging with respect to pixels provided in Pattern 8.

FIG. 14 is a waveform chart showing a reference embodiment of the present invention: (a) of FIG. 14 is a waveform chart illustrating an example of power consumption in the pre-charging and the main-charging, and (b) of FIG. 14 is a waveform chart illustrating another example of power consumption in the pre-charging and the charging.

FIG. 15 is a view illustrating a pixel arrangement pattern of the reference embodiment.

FIG. 16 is a circuit block diagram illustrating an arrangement of a gate driver of the reference embodiment.

FIG. 17 is a circuit diagram illustrating an arrangement of a shift register stage of the reference embodiment.

FIG. 18 is a timing chart showing an operation of the gate driver of the reference embodiment.

FIG. 19 is a view illustrating an arrangement of pixels in a panel in accordance with conventional techniques: (a) of FIG. 19 illustrates an arrangement of pixels; and (b) of FIG. 19 illustrates another arrangement of pixels.

FIG. 20 is a circuit block diagram illustrating an arrangement of a first gate driver in accordance with the conventional technique.

FIG. 21 is a circuit block diagram illustrating an arrangement of a second gate driver in accordance with the conventional technique.

FIG. 22 is a timing chart showing an operation of the first gate driver of FIG. 20 in accordance with the conventional technique.

FIG. 23 is a timing chart showing an operation of the second gate driver of FIG. 21 in accordance with the conventional technique.

FIG. 24 is a circuit diagram illustrating an arrangement of a shift register stage in accordance with the conventional technique.

FIG. 25 is a timing chart illustrating an operation of the circuit of FIG. 24 in accordance with the conventional technique.

FIG. 26 is a timing chart showing an operation of another gate driver in accordance with the conventional technique.

FIG. 27 is a view illustrating a problem of the first gate driver in accordance with the conventional technique.

FIG. 28 is a view illustrating a problem of the second gate driver in accordance with the conventional technique.

FIG. 29 is a view illustrating a problem of the gate driver in accordance with the conventional technique.

### REFERENCE SIGNS LIST

1: Liquid crystal display device (display device)
5: Gate driver (scan signal line driving circuit)
11: Liquid crystal display device (display device)
15a: Gate driver (scan signal line driving circuit, first scan signal line driving circuit)
15b: Gate driver (scan signal line driving circuit, second scan signal line driving circuit)

### DESCRIPTION OF EMBODIMENTS

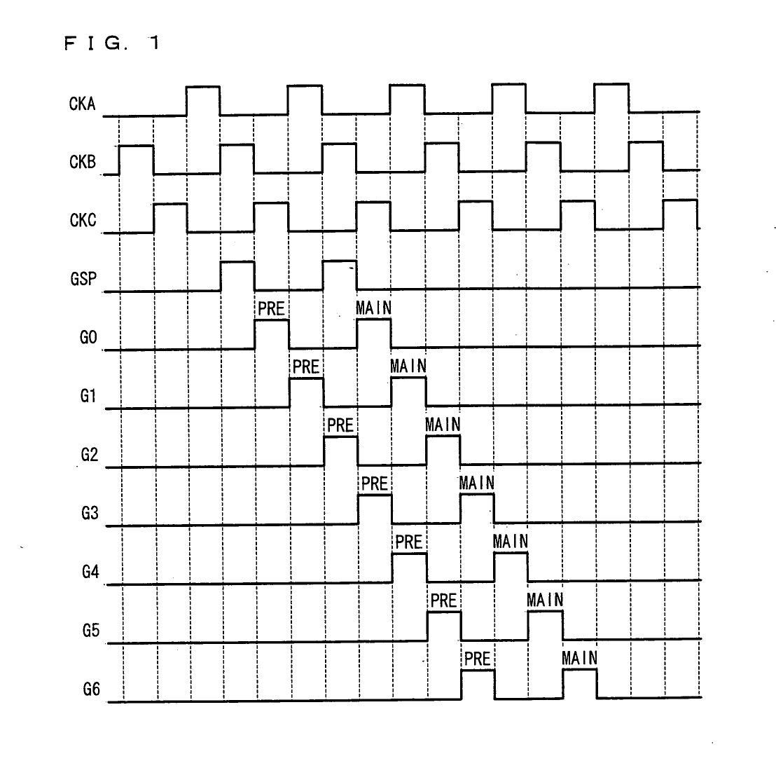

One embodiment of the present invention is described below with reference to FIGS. 1 through 18.

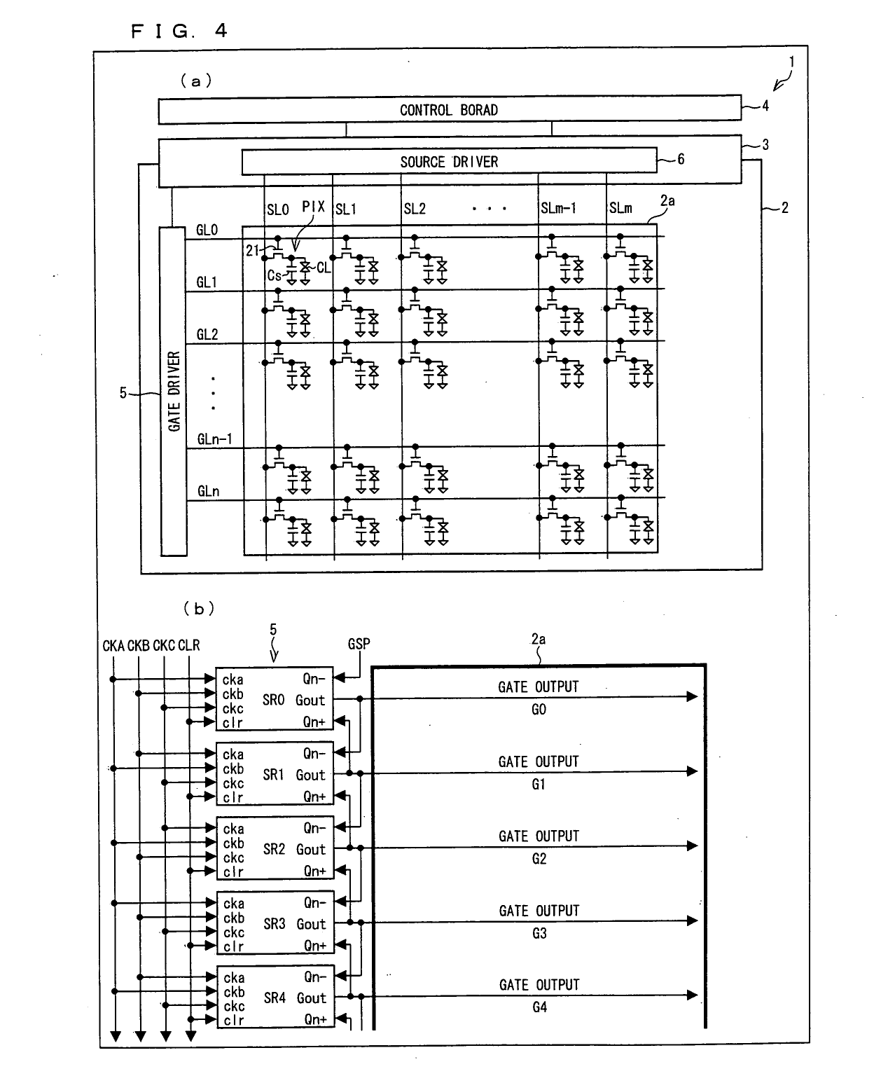

(a) of FIG. 4 illustrates an arrangement of a first liquid crystal display device (display device) 1 in accordance with the present embodiment.

The liquid crystal display device 1 includes: a display panel 2, a flexible printed circuit board 3, and a control board 4.

The display panel 2 is an active matrix display panel in which a display region 2a, a plurality of gate lines (scan signal lines) GL, a plurality of source lines (data signal lines) SL, and a gate driver (scan signal line driving circuit) 5 are provided on a glass substrate by use of amorphous silicon, polycrystalline silicon, CG silicon, or microcrystalline silicon. The display region 2a is a region in which a plurality of pixels PIX are arranged in a matrix pattern. Each of the plurality of pixels PIX includes: a TFT 21 serving as a pixel selection element; a liquid crystal capacitance CL; and a storage capacitance Cs. A gate of the TFT 21 is connected to a corresponding one of the plurality of gate lines GL, and a source of the TFT 21 is connected to a corresponding one of the plurality of source lines SL. The liquid crystal capacitance CL and the storage capacitance Cs are connected to a drain of the TFT 21.

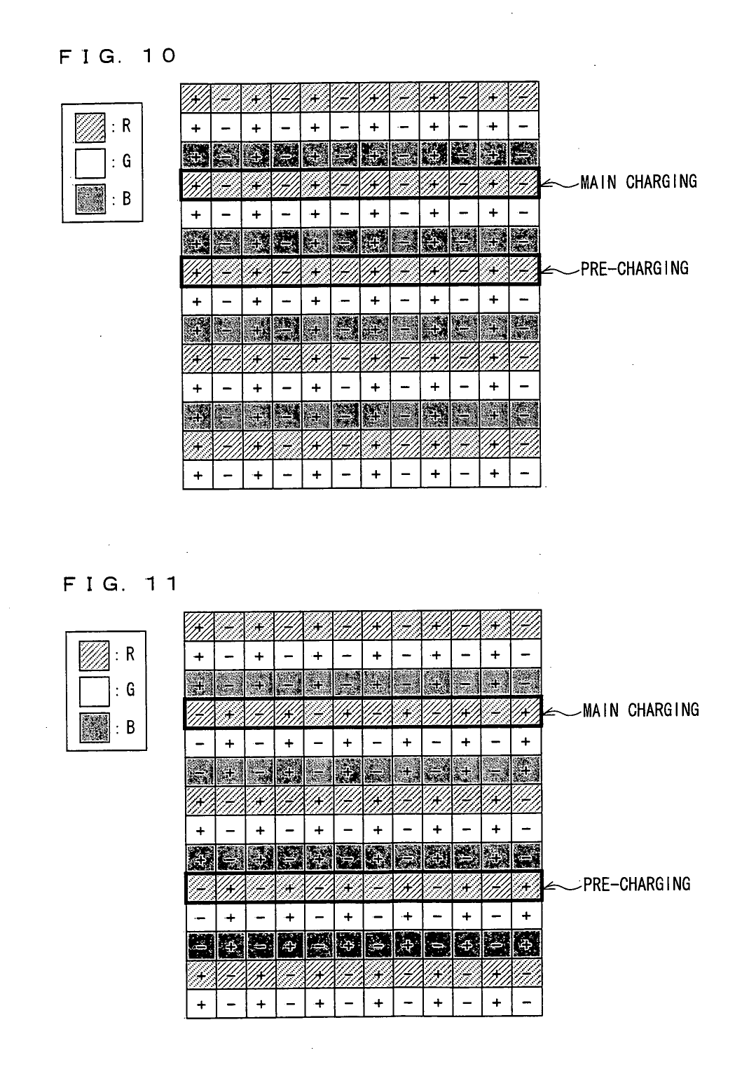

Further, each of the plurality of pixels PIX has a display color which may be one of three colors of three-color pixels, such as R, G, and B. These pixels having respective three colors are, hereinafter, referred to as “first color pixel”, “second color pixel”, and “third color pixel”, respectively. Each of the plurality of source lines SL is connected to part of the first, second, and third color pixels correspondingly such that an array unit in which one first color pixel, one second color pixel, and one third color pixel are arranged in a predetermined order (e.g., an R pixel, a G pixel, and a B pixel are arranged in this order) along a direction in which the plurality of source lines SL extend is repeated along each of the plurality of source lines SL (later described with reference to FIG. 10).

The plurality of gate lines GL, namely gate lines GL0, GL1, GL2, . . . GLn, are connected to outputs of the gate driver 5, respectively. The plurality of source lines SL, namely source lines SL0, SL1, SL2, . . . SLm, are connected to outputs of a source driver 6 (later described), respectively. Further, a plurality of storage capacitance lines (not illustrated) are provided so that each of the storage capacitance Cs of the pixels PIX receives a storage capacitance voltage via a corresponding one of the plurality of storage capacitance lines.

The gate driver 5 is provided on the display panel 2 and in a region adjoining the display region 2a at one of sides of the display region 2a, which sides are opposite to each other in the direction in which the plurality of gate lines GL extend. The gate driver 5 sequentially supplies gate pulses (scan pulses) to the plurality of gate lines GL, respectively. The gate driver 5 and the display region 2a are monolithically formed in the display panel 2. Examples of the gate driver 5 of the present embodiment encompass any gate drivers, provided that the gate driver is monolithically formed in the display panel by the technique called “monolithic gate driver”, “gate driver-free”, “built-in gate driver in panel”, “gate-in panel”, or the like.

The flexible printed circuit board 3 includes the source driver 6. The source driver 6 supplies data signals to the plurality of source lines SL, respectively. Note that the source driver may be the one provided on the panel by, for example, a widely-known COG (Chip On Glass) technique. The flexible printed circuit board 3 and the control substrate 4 are connected to each other. The flexible printed circuit board 3 receives, from the control substrate 4, signals and power sources, so as to supply the signals and the power sources to the gate driver 5 and the source driver 6. The flexible printed circuit board 3 supplies corresponding signals and power source, received from the control substrate 4, to the gate driver 5 through a surface area of the display panel 2.

Note here that the liquid crystal display device 1 is subjected to AC driving employing a source line inversion technique. That is, the pixels PIX connected to the same source line SL receive, respectively, the data signals having the same polarity, and simultaneously, the data signals supplied to the respective pixels PIX connected to the same source line SL are opposite in polarity to those supplied to pixels PIX connected to neighboring source lines SL.

(b) of FIG. 4 illustrates an arrangement of the gate driver 5.

The gate driver 5 includes a shift register in which a plurality of shift register stages SR (SR0, SR1, SR2 . . . ) are connected in cascade. Each of the shift register stages SR includes: a set input terminal Qn−; an output terminal Gout; a reset input terminal Qn+; clock input terminals cka, ckb, and ckc; and a clear terminal clr. The gate driver 5 receives, from the control substrate 4, a clock signal (first clock signal) CKA, a clock signal (second clock signal) CKB, a clock signal (third clock signal) CKC, a clear signal CLR, a gate start pulse (shift pulse) GSP, and a Low power source serving as a power source. The Low power source may have a negative electric potential, a GND electric potential, or a positive electric potential. Here, in order to ensure that the TFT can be turned off properly, the Low power source has a negative electric potential.

The ith (i=0, 1, 2 . . . ) gate line receives a gate output Gi from the output Gout of the ith shift register stage SRi.

The first shift register stage SR0, i.e. an endmost stage in a scanning direction, receives the gate start pulse GSP via its input terminal Qn−, while each subsequent ith shift register stage SRi (SR1, SR2 . . . ) receives a gate output Gi−1 from a preceding shift register stage SRi−1. Further, each ith shift register stage SRi receives, via its reset input terminal Qn+, a gate output Gi+1 from a subsequent shift register stage SRi+1.

The first shift register stage SR0 receives: the clock signal CKA via its clock input terminal cka; the clock signal CKB via its clock input terminal ckb; and the clock signal CKC via its clock input terminal ckc. The same goes for shift register stages SR located every three shift register stages

SR from the shift register stage SR0. The second shift register stage SR1 receives: the clock signal CKB via its clock input terminal cka; the clock signal CKA via its clock input terminal ckb; and the clock signal CKC via its clock input terminal ckc. The same goes for shift register stages SR located every three shift register stages SR from the shift register stage SR1. The third shift register stage SR2 receives: the clock signal CKC via its clock input terminal cka; the clock signal CKA via its clock input terminal ckb; and the clock signal CKB via its clock input terminal ckc. The same goes for shift register stages SR located every three shift register stages SR from the shift register stage SR2.

The clock signals CKA, CKB, and CKC have waveforms shown in FIG. 1, respectively. Clock pulses of the clock signals CKA, CKB, and CKC do not overlap with one another. The clock pulse of the clock signal CKC is followed by the clock pulse of the clock signal CKA, the clock pulse of the clock signal CKA is followed by the clock pulse of the clock signal CKB, and the clock pulse of the clock signal CKB is followed by the clock pulse of the clock signal CKC.

Each of the shift register stages SR receives, via its clear terminal, the clear signal CLR by which the entire shift register is initialized.

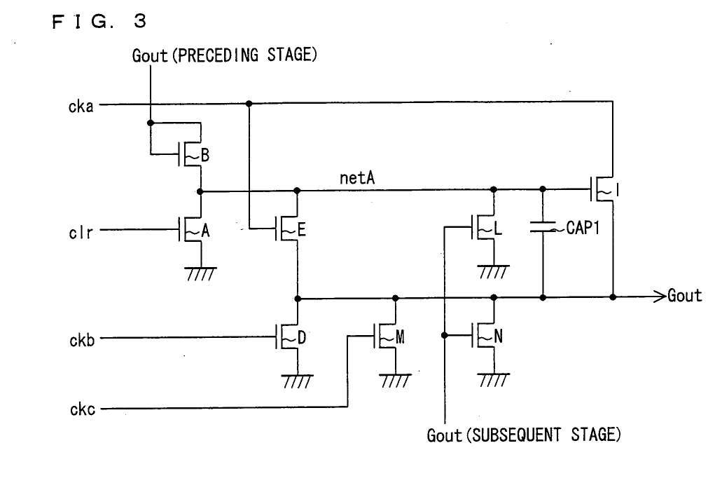

Next, FIG. 3 illustrates an arrangement of the shift register stage SRi.

The shift register stage SRi includes transistors A, B, D, E, I, L, M and N, and a capacitance CAP1. All of the transistors are of an n-channel type.

The transistor B is such that its gate and drain are connected to the output terminal Gout of the preceding shift register stage SRi−1 and its source is connected to a gate of the transistor I. The transistor I is such that its drain is connected to the clock input terminal cka and its source is connected to the output terminal Gout of the shift register stage SRi. That is, the transistor I either transmits or blocks the clock signal received by the clock input terminal cka. The capacitance CAP1 is connected between the gate and source of the transistor I. A node having the same electric potential as that of the gate of the transistor I is referred to as “net A”.

The transistor D is such that its gate is connected to the clock input terminal ckb, its drain is connected to the output terminal Gout of the shift register stage SRi, and its source is connected to the Low power source. The transistor M is such that its gate is connected to the clock input terminal ckc, its drain is connected to the output terminal Gout of the shift register stage SRi, and its source is connected to the Low power source.

The transistor L is such that its gate is connected to the output terminal Gout of the subsequent shift register stage SRi+1, its drain is connected to the node net A, and its source is connected to the Low power source. The transistor N is such that its gate is connected to the output terminal Gout of the subsequent shift register stage SRi+1, its drain is connected to the output terminal Gout of the shift register stage SRi, and its source is connected to the Low power source.

The transistor E is such that its gate is connected to the clock input terminal cka, its drain is connected to the node net A, its source is connected to the output terminal Gout of the shift register stage Sri. The transistor A is such that its gate is connected to the clear terminal clr, its drain is connected to the node net A, and its source is connected to the Low power source.

Next, the following description deals with an operation of the shift register stage Sri having the arrangement of FIG. 3.

When the liquid crystal display device 1 is started to display images, each shift register stage SRi simultaneously receives a pulse of the clear signal CLR. It follows that the transistor A is turned on so that an electric potential of the node net A is initialized to be that of the Low power source. The transistor B is kept being in an off-state until the shift register stage SRi receives a gate pulse from the output terminal Gout of the preceding shift register stage SRi−1. In this state, every time the clock input terminals cka, ckb, and ckc receive corresponding clock pulses of the clock signals CKA, CKB, and CKC (see FIG. 1), respectively, the transistors E, D, and M are turned on in turn so as to refresh the electric potentials of the node net A and the output terminal Gout of the shift register stage SRi to be that of the Low power source.

When the shift register stage SRi receives the gate pulse from the output terminal Gout of the preceding shift register stage SRi−1, the transistor B is turned on so that the capacitance CAP1 is charged. As the capacitance CAP1 is gradually charged, the transistor I is turned on. It follows that the transistor I receives, via it source, the clock signal received by the clock input terminal cka. However, as soon as the next clock pulse is received, the electric potential at the node net A is rapidly boosted due to a bootstrap effect of the capacitance CAP1 so that the received clock pulse is outputted to the output terminal Gout of the shift register stage SRi as a gate pulse.

When the input of the gate pulse from the preceding shift register stage SRi−1 is completed, the transistor B is turned off. Here, the node net A and the output terminal Gout of the shift register stage SRi become in the floating state and maintain their charges. In order to release the charges, the transistors L and N are turned on by the gate pulse received from the output terminal Gout of the subsequent stage SRi+1 so as to cause the electric potentials of the node net A and the output terminal Gout of the shift register stage SRi to be that of the Low power source.

After that, the process described above is repeated again until the shift register stage SRi receives the gate pulse from the output terminal Gout of the preceding shift register stage SRi−1 again. That is, the transistors E, D, and M are turned on in turn by the respective clock pulses which are received by the clock input terminals cka, ckb, and ckc, respectively, so as to refresh the electric potentials of the node net A and the output terminal Gout of the shift register stage SRi to be that of the Low power source.

Next, the following description deals with pre-charging and main-charging with respect to each of the plurality of pixels PIX in the liquid crystal display device 1. In the following description, the above explanations are applied to the timing chart of FIG. 1.

The first shift register stage SR0 receives the gate start pulse GSP, which serves as the gate pulse received from the preceding register stage SRi−1, illustrated in FIG. 3. Here, the gate start pulse GSP is constituted by two pulses which are away from each other by two clock pulses, i.e. two pulses are away from each other by a cycle period from the clock signal CKA to the clock signal CKC. These two pulses are synchronized with the clock pulses of the clock signal CKB.

When the shift register stage SR0 receives the gate start pulse GSP, the shift register SR0 outputs, in accordance with the input of the clock pulse of the clock signal CKC, a gate output G0 having the gate pulse. Among the two gate pulses of the gate start pulse GSP, the first gate pulse is a pulse for pre-charging the pixels PIX connected to the gate line GL0. However, there is no pixel for displaying images in the upstream of the pixel. For this reason, as the first gate pulse for the pre-charging, a signal prepared during a vertical blanking interval after a previous frame period can be supplied to each of the plurality of source lines SL, for example. This method is exemplified by the following two methods, for example.

One secures correlation between data for the pre-charging and data for the main-charging by (i) storing digital data of the pixels PIX connected to the gate line G0 in the previous frame, and (ii) supplying the digital data for the pre-charging with respect to the gate line G0, as the data signals having the polarity of the next frame. In this method, digital data of the pixels PIX connected to three gate lines GL0 to GL2 in the previous frame is stored, and is supplied in turn to pre-charge these pixels PIX. This method has an advantage of high display quality.

Another pre-charges the pixels PIX connected to the gate lines GL0 to GL2 by use of masked data received during the vertical blanking interval. In this method, each of the pixels PIX are pre-charged with the masked data, which is normal data in the vertical blanking interval. For this reason, this method has an advantage of easiness in carrying out the process.

The first pulse of the gate start pulse GSP becomes the gate pulse of the gate output G0, and simultaneously is shifted to the shift register stage SR1. Then, the gate pulse is outputted from the shift register stage SR1 as the gate pulse of the gate output G1, in accordance with the input of the clock pulse of the next clock signal, i.e. the clock signal CKA. In the same manner, the gate pulse of the gate output G1 is simultaneously shifted to the shift register stage SR2, and then is outputted from the shift register stage SR2 as the gate pulse of the gate output G2, in accordance with the input of the clock pulse of the next clock signal, i.e. the clock signal CKB.

Further, the second pulse of the gate start pulse GSP, synchronized with the clock pulse of the clock signal CKB, is supplied to the first shift register stage SR0. Then, the gate pulse for the main-charging is outputted from the shift register stage SR0 in accordance with the input of the clock pulse of the next clock signal, i.e. the clock pulse CKC. At this point, each of the plurality of source lines SL receives the data signals so as to supply the data signals to the respective pixels PIX connected to the gate line GL0. Simultaneously with the output of the gate pulse for the main-charging from the shift register stage SR0, the shift register stage SR3 supplies, to the gate line GL3, the gate output G3 having the gate pulse for the pre-charging. The pixels PIX connected to the gate line GL3 are pre-charged with the data signals supplied to the pixel PIX connected to the gate line GL0. Here, the pixels PIX connected to the gate line GL3 has the same color as the pixels PIX connected to the gate line GL0. Further, the pixels PIX connected to the gate line GL3 are connected to the plurality of source lines SL, respectively, and the pixels PIX connected to the gate line GL0 are connected to the same plurality of source lines SL, respectively. Therefore, the data signals supplied to the pixels PIX connected to the gate line GL0 are close in electric potential to the data signals supplied to the pixels PIX connected to the gate line GL3, and are suitable for pre-charging the pixels PIX connected to the gate line GL3.

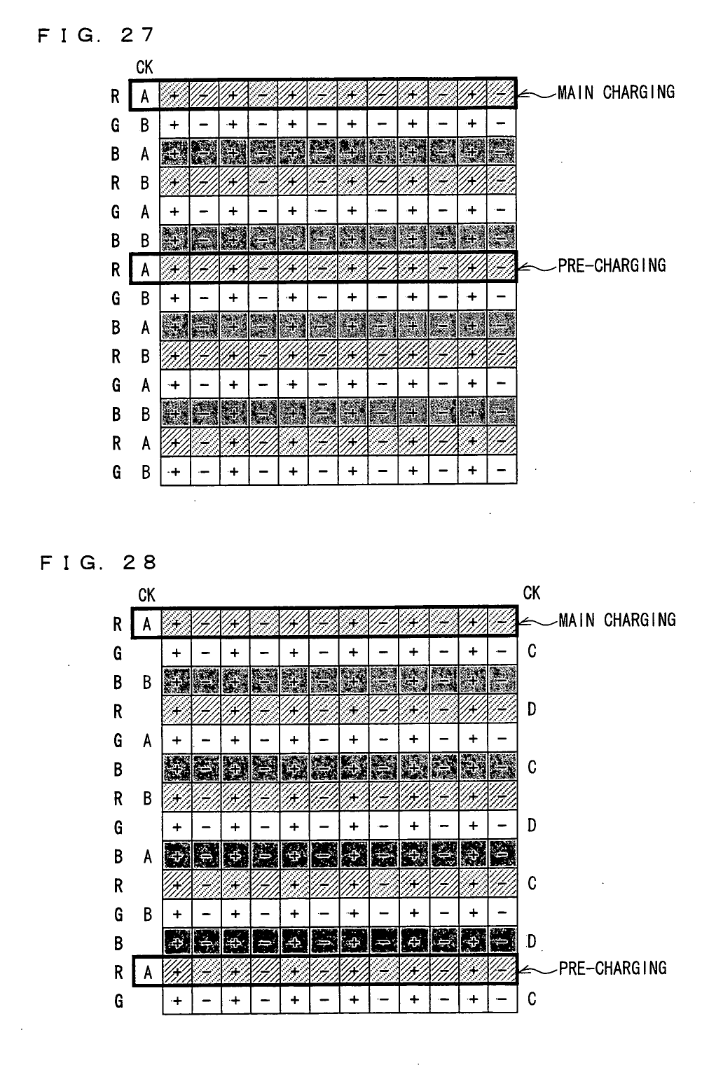

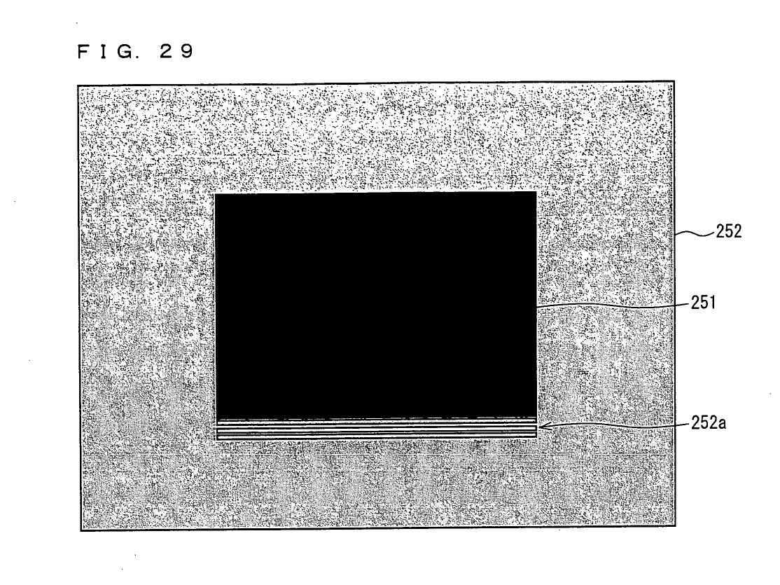

The pixels PIX connected to the gate line GL4 are pre-charged with the data signals supplied to the pixels PIX connected to the gate line GL1, respectively, the pixels PIX connected to the gate line GL5 are pre-charged with the data signals supplied to the pixels PIX connected to the gate line GL2, and the same goes for the subsequent stages. Each of the plurality of pixels PIX is thus pre-charged with the data signal supplied to the pixel PIX which (i) is located three lines before the each of the plurality of pixels PIX and connected to the same source line as the each of the plurality of pixels PIX and (ii) has the same color as the each of the plurality of pixels PIX. Accordingly, in the liquid crystal display device in which all of the plurality of gate lines are driven by a single gate driver, it is possible to pre-charge a target pixel with an electric potential which is closer to that of a data signal for main-charging the target pixel, as compared with the conventional technique (see FIG. 27) in which the target pixel is pre-charged with the data signal supplied to the pixel which (i) has the same color as the target pixel and (ii) is located away from the target pixel by at least six lines.

Note that in the liquid crystal display device 1, the target pixel may be pre-charged with the data signal supplied to the pixel which has the same color as the target pixel and is located farther away from the target pixel, such as the pixel located six or nine lines before the target pixels, by causing the interval between the two pulses of the gate start pulse GSP to be a multiple of the cycle period from the clock signal CKA to the clock signal CKC, such as an interval equivalent of a period of five or eight clock pulses.

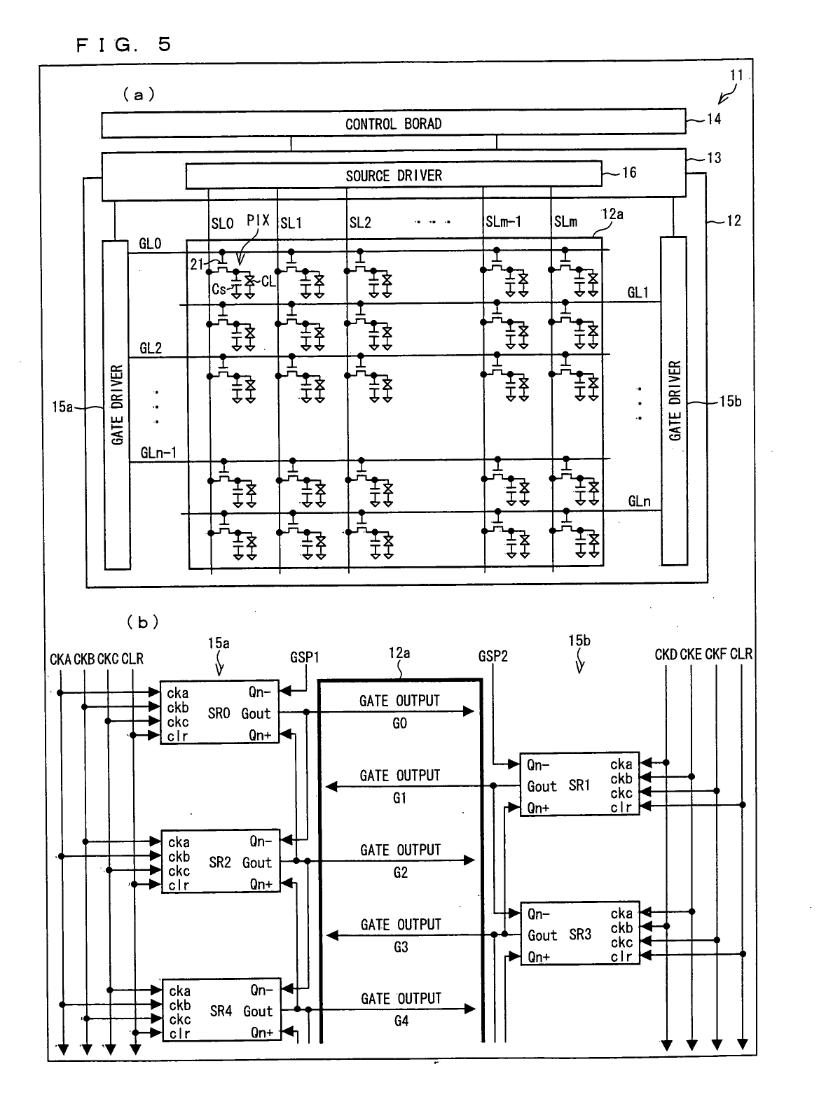

(a) of FIG. 5 illustrates an arrangement of a second liquid crystal display device (display device) 11 in accordance with the present embodiment.

The liquid crystal display device 11 includes: a display panel 12; a flexible printed circuit board 13; and a control substrate 14.

The display panel 12 is an active matrix display panel in which a display region 12a, a plurality of gate lines (scan signal lines) GL, a plurality of source lines (data signal lines) SL, and gate drivers (scan signal line driving circuits) 15a and 15b are provided on a glass substrate by use of amorphous silicon, polycrystalline silicon, CG silicon, or microcrystalline silicon. The display region 12a has the same arrangement as that of the display region 2a illustrated in (a) of FIG. 4.

The plurality of gate lines GL, namely GL0, GL1, GL2 . . . GLn, are categorized into two groups, i.e. first gate lines (gate lines GL0, GL2, GL4 . . . , located every two lines) and second gate lines (gate lines other than the first gate lines among the plurality of gate lines GL, i.e. gate lines GL1, GL3, GL5 . . . , located every two lines). The first gate lines GL (GL0, GL2, GL4 . . . ) are connected to outputs of the gate driver (first scan signal line driving circuit) 15a, respectively, while the second gate lines GL (GL1, GL3, GL5 . . . ) are connected to outputs of the gate driver (second scan signal line driving circuit) 15b, respectively. The plurality of source lines SL, namely SL0, SL1, SL2 . . . SLm, are connected to outputs of a source driver 16 (later described), respectively. Further, a plurality of storage capacitance lines (not illustrated) are provided so that each of storage capacitance Cs of the pixels PIX receives a storage capacitance voltage via a corresponding one of the plurality of storage capacitance lines.

The gate driver 15a is provided adjacent to one of edges of the display region 12a on the display panel 12, to which edges the plurality of gate lines GL extend. The gate driver 15a sequentially supplies gate pulses (scanning pulses) to the first gate lines (GL0, GL2, GL4 . . . ), respectively. The gate driver 15b is provided adjacent to the other one of edges of the display region 12a on the display panel 12, to which edges the plurality of gate lines GL extend. The gate driver 15b supplies gate pulses (scanning pulses) to the second gate lines (GL1, GL3, GL5 . . . ), respectively. These gate drivers 15a and 15b and the display region 12a are monolithically formed in the display panel 12. Examples of the gate drivers 15a and 15b of the present embodiment encompass any gate drivers, provided that the gate driver is monolithically formed in the display panel by the technique called “monolithic gate driver”, “gate driver-free”, “built-in gate driver in panel”, “gate-in panel”, or the like.

The flexible printed circuit board 13 includes the source driver 16. The source driver 16 supplies data signals to the plurality of source lines SL, respectively. Note that the source driver may be the one provided on the panel by, for example, a widely-known COG (Chip On Glass) technique. The flexible printed circuit board 13 and the control substrate 14 are connected to each other. The flexible printed circuit board 13 receives, from the control substrate 4, signals and power sources, so as to supply the signals and the power sources to the gate drivers 15a and 15b and the source driver 16. The flexible printed circuit board 13 supplies corresponding signals and power source, received from the control substrate 14, to the gate drivers 15a and 15b on the display panel 12.

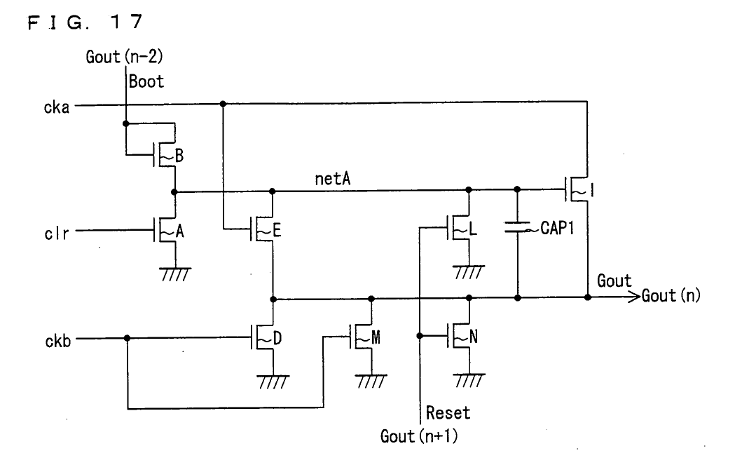

(b) of FIG. 15 illustrates arrangements of the respective gate drivers 15a and 15b.

The gate driver 15a includes a first shift register in which a plurality of shift register stages SR (SR0, SR2, SR4 . . . ) are connected in cascade. Each of the shift register stages SR includes: a set input terminal Qn−; an output terminal Gout; a reset input terminal Qn+; clock input terminals cka, ckb, and ckc; and a clear terminal clr. The gate driver 15a receives, from the control substrate 14, a clock signal (first clock signal) CKA, a clock signal (second clock signal) CKB, a clock signal (third clock signal) CKC, a clear signal CLR, a gate start pulse (first shift pulse) GSP1, and a Low power source serving as a power source. The Low power source may have a negative electric potential, a GND electric potential, or a positive electric potential. Here, in order to ensure that the TFT can be turned off properly, the Low power source has a negative electric potential.

The ith (i=0, 2, 4 . . . ) gate line receives a gate output Gi from the output Gout of the jth shift register stage SRi (j=1, 2, 3 . . . , j=i/2+1) of the first shift register.

The first (with regard to “j”) shift register stage SR0, i.e. an endmost stage in a scanning direction, receives the gate start pulse GSP1 via its input terminal Qn−, while each subsequent shift register stage SRi (SR2, SR4 . . . ) receives a gate output Gi−2 from a preceding shift register stage SRi−2. Further, each ith shift register stage SRi receives, via its reset input terminal Qn+, a gate output Gi+2 from a subsequent shift register stage SRi+2.

The first (with regard to “j”) shift register stage SR0 receives: the clock signal CKA via its clock input terminal cka; the clock signal CKB via its clock input terminal ckb; and the clock signal CKC via its clock input terminal ckc. The same goes for shift register stages SR located every three shift register stages SR from the shift register stage SR0. The second (with regard to “j”) shift register stage SR2 receives: the clock signal CKB via its clock input terminal cka; the clock signal CKA via its clock input terminal ckb; and the clock signal CKC via its clock input terminal ckc. The same goes for shift register stages SR located every three shift register stages SR from the shift register stage SR2. The third (with regard to “j”) shift register stage SR4 receives: the clock signal CKC via its clock input terminal cka; the clock signal CKA via its clock input terminal ckb; and the clock signal CKB via its clock input terminal ckc. The same goes for shift register stages SR located every three shift register stages SR from the shift register stage SR4.

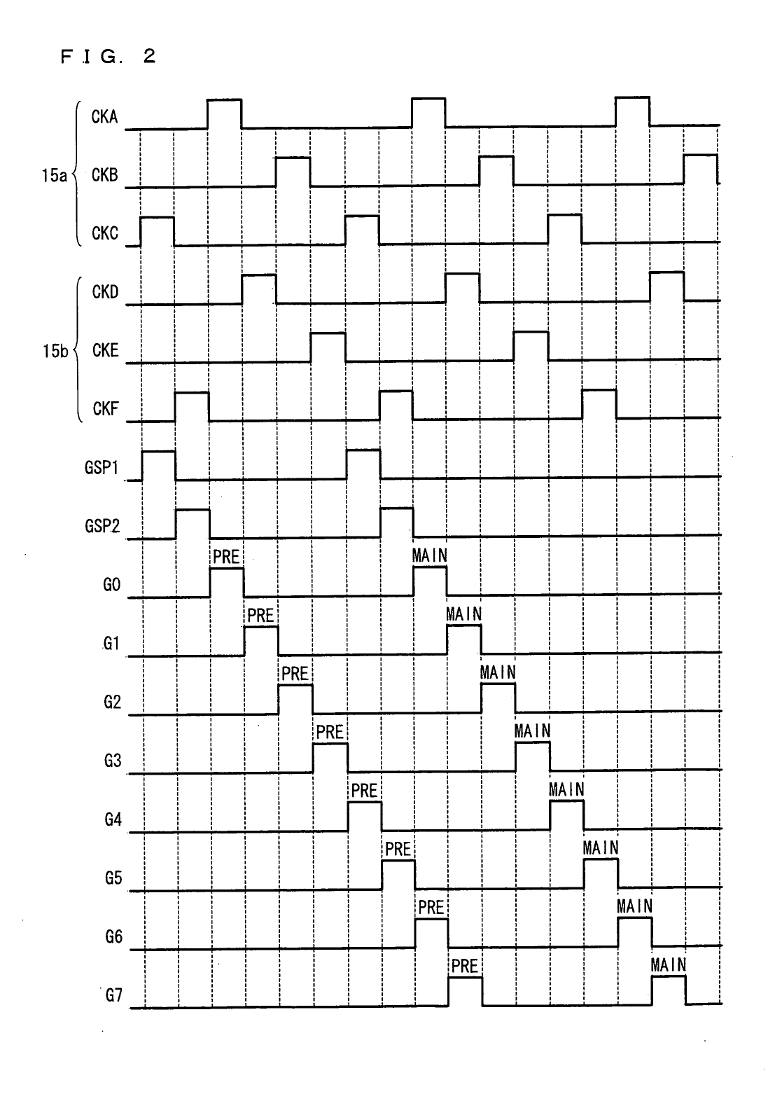

The clock signals CKA, CKB, and CKC have waveforms shown in FIG. 2, respectively. Clock pulses of the clock signals CKA, CKB, and CKC do not overlap with one another. The clock pulse of the clock signal CKC is followed by the clock pulse of the clock signal CKA with an interval of one clock pulse therebetween, the clock pulse of the clock signal CKA is followed by the clock pulse of the clock signal CKB with an interval of one clock pulse therebetween, and the clock pulse of the clock signal CKB is followed by the clock pulse of the clock signal CKC with an interval of one clock pulse therebetween.

Each of the shift register stages SR receives, via its clear terminal, the clear signal CLR by which the entire shift register is initialized.

The gate driver 15b includes a second shift register in which a plurality of shift register stages SR (SR1, SR3, SR5 . . . ) are connected in cascade. Each of the plurality of shift register stages SR includes: a set input terminal Qn−; an output terminal Gout; a reset input terminal Qn+; clock input terminals cka, ckb, and ckc; and a clear terminal clr. The gate driver 15b receives, from the control substrate 14, a clock signal (fourth clock signal) CKD, a clock signal (fifth clock signal) CKE, a clock signal (sixth clock signal) CKF, the clear signal CLR, a gate start pulse (second shift pulse) GSP2, and a Low power source serving as a power source. The Low power source may have a negative electric potential, a GND electric potential, or a positive electric potential. Here, in order to ensure that the TFT can be turned off properly, the Low power source has a negative electric potential.

The ith (i=1, 3, 5 . . . ) gate line receives a gate output Gi from the output Gout of the kth shift register stage SRi (k=1, 2, 3 . . . , k=(i+1)/2) of the second shift register. The first (with regard to “k”) shift register stage SR1, i.e. an endmost stage in the scanning direction, receives the gate start pulse GSP2 via its input terminal Qn−, while each subsequent shift register stage SRi (SR3, SR5 . . . ) receives a gate output Gi−2 from a preceding shift register stage SRi−2. Further, each ith shift register stage SRi receives, via its reset input terminal Qn+, a gate output Gi+2 from a subsequent shift register stage SRi+2.

The first (with regard to “k”) shift register stage SR1 receives: the clock signal CKD via its clock input terminal cka; the clock signal CKE via its clock input terminal ckb; and the clock signal CKF via its clock input terminal ckc. The same goes for shift register stages SR located every three shift register stages SR from the first shift register stage SR1. The second (with regard to “k”) shift register stage SR3 receives: the clock signal CKE via its clock input terminal cka; the clock signal CKD via its clock input terminal ckb; and the clock signal CKF via its clock input terminal ckc. The same goes for shift register stages SR located every three shift register stages SR from the second shift register stage SR3. The third (with regard to “k”) shift register stage SR5 receives: the clock signal CKF via its clock input terminal cka; the clock signal CKD via its clock input terminal ckb; and the clock signal CKE via its clock input terminal ckc. The same goes for shift register stages SR located every three shift register stages SR from the third shift register stage SR5.

The clock signals CKD, CKE, and CKF have waveforms shown in FIG. 2, respectively. Clock pulses of the clock signals CKD, CKE, and CKF do not overlap with one another. The clock pulse of the clock signal CKF is followed by the clock pulse of the clock signal CKD with an interval of one clock pulse therebetween, the clock pulse of the clock signal CKD is followed by the clock pulse of the clock signal CKE with an interval of one clock pulse therebetween, and the clock pulse of the clock signal CKE is followed by the clock pulse of the clock signal CKF with an interval of one clock pulse therebetween.

Each of the shift register stages SR receives, via its clear terminal, the clear signal CLR by which the entire shift register is initialized.

Further, as shown in FIG. 2, the clock signals CKA, CKB, CKC, CKD, CKE, and CKF are such that: the clock signal CKF is followed by the clock signal CKA; the clock signal CKA is followed by the clock signal CKD; the clock signal CKD is followed by the clock signal CKB; the clock signal CKB is followed by the clock signal CKE; the clock signal CKE is followed by the clock signal CKC; and the clock signal CKC is followed by the clock signal CKF.

Each of the gate start pulses GSP1 and GSP2 is constituted by two pulses away from each other with an interval of five clock pulses therebetween, i.e. the two pulses are away from each other by the cycle period from the clock signal CKA to the clock signal CKF. The two pulses of the gate start pulse GSP1 are synchronized with the clock pulses of the clock signal CKC, and the two pulses of the gate start pulses GSP2 are synchronized with the clock pulses of the clock signal CKF. Here, the pulses of the gate start pulses GSP2 are delayed from those of the gate start pulse GSP1. Note, however, that in order to carry out the pre-charging in accordance with the present embodiment, the gate start pulses GSP1 and GSP2 do not necessarily have a phase difference with each other. Basically, the gate start pulses GSP1 and GSP2 may be signals identical with each other.

Each of the shift register stages SR has the arrangement illustrated in FIG. 3.

Next, the following description deals with the pre-charging and the main-charging with respect to each of the plurality of pixels PIX of the liquid crystal display device 11.

Each of the gate drivers 15a and 15b functions, independently, on the same principle as the gate driver 5 of the liquid crystal display device 1. However, as shown in FIG. 2, when one of the gate drivers 15a and 15b supplies, to the gate line GLi, the gate output Gi for the main-charging, the one of the gate derivers 15a and 15b supplies, to the gate line GLi+6, the gate output Gi+6 for the pre-charging. That is, the pre-charging is carried out by a data signal supplied to a pixel which is connected to the same source line as the target pixel and is located six lines before the target pixel.

Accordingly, in the liquid crystal display device in which the plurality of gate lines are driven by two gate drivers alternatively, it is possible to pre-charge a target pixel with an electric potential which is closer to that of a data signal for main-charging the target pixel, as compared with the conventional technique (see FIG. 28) in which the target pixel is pre-charged with the data signal supplied to the pixel which has the same color as the target pixel and is located at least twelve lines away from the target pixel.

Note that in the liquid crystal display device 11, the target pixel can be pre-charged with the data signal supplied to the pixel which has the same color as the target pixel and is located farther away from the target pixel, such as 12 or 18 lines before the target pixels, by causing the interval between the two pulses of each of the gate start pulses GSP1 and GSP2 to be a multiple of the cycle period from the clock signal CKA to the clock signal CKF, such as an interval equivalent of a period of 11 or 17 clock pulses.

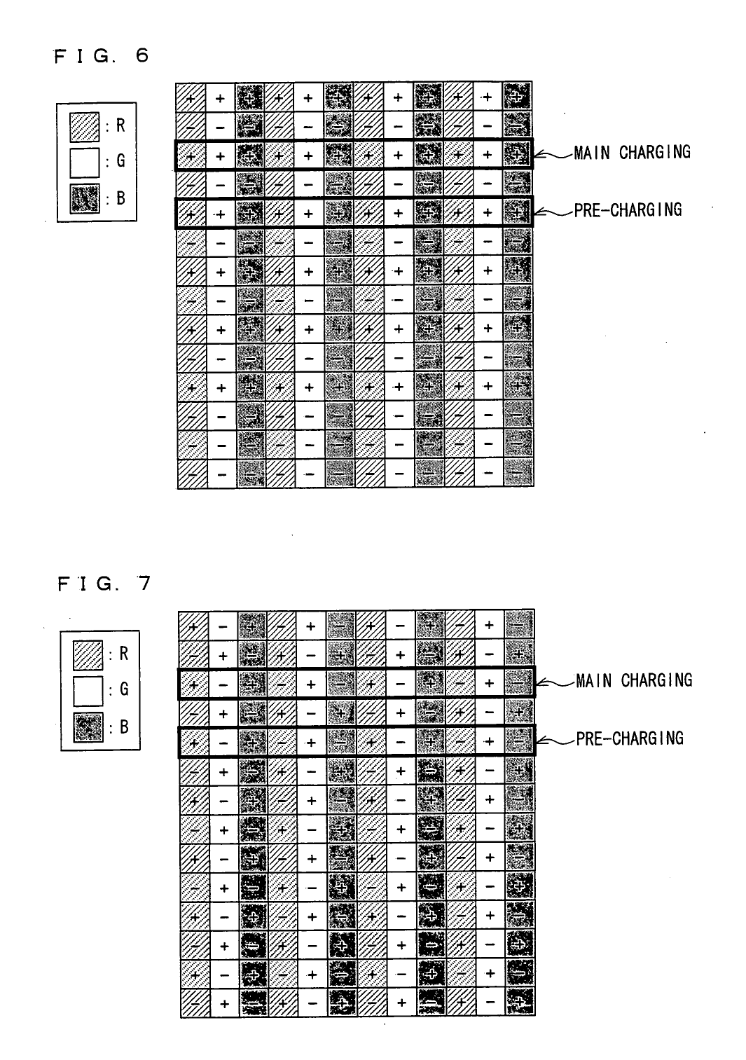

The following description deals with effects of the present invention for various patterns of an arrangement of the plurality of pixels PIX in the display region 2a of the liquid crystal display device 1, with reference to FIGS. 6 through 13.

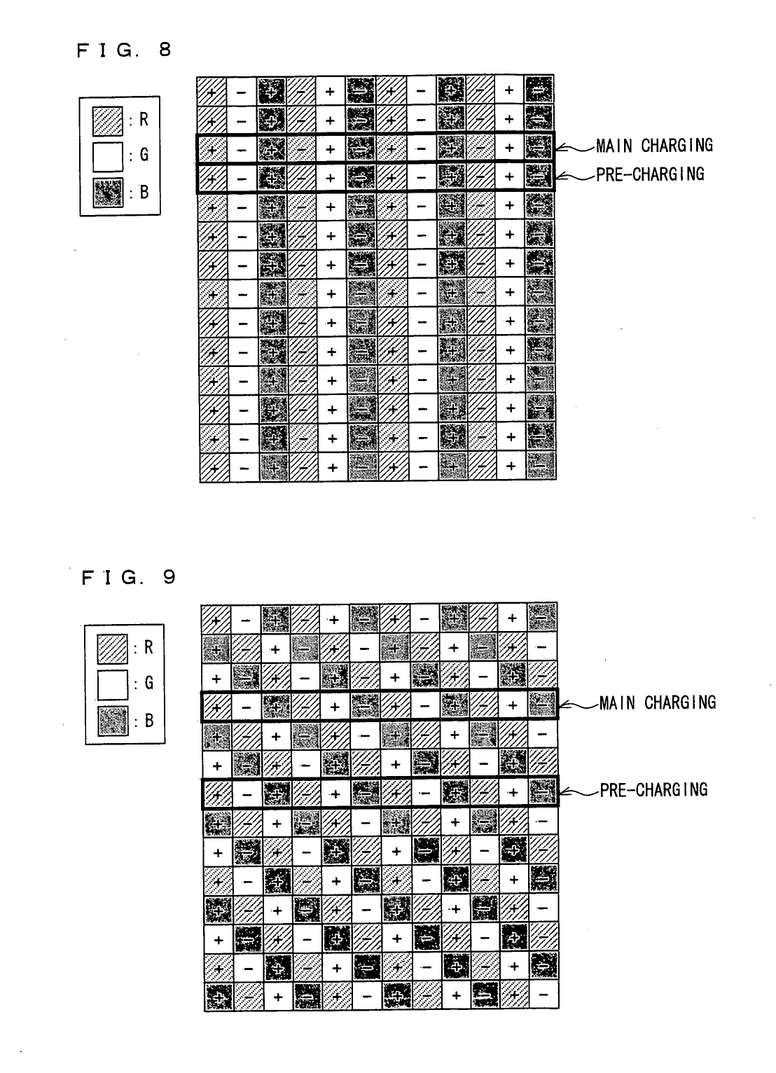

Each of FIGS. 6 through 8 illustrates a comparative example. Each of FIGS. 6 through 8 shows a relationship between the pre-charging and the main-charging for each of the various patterns of the arrangement of the plurality of pixels PIX in the liquid crystal display device in which the source drivers are provided in accordance with the three colors R, G, and B. In each of FIGS. 6 through 8, the pixels connected to the same source line SL have the same color. FIG. 6 illustrates a case (pattern 1) where the liquid crystal display device 1 is subjected to AC driving employing a gate line inversion technique. In this case, it is always possible to pre-charge the target pixel by the data signal supplied to the pixel which has the same color as the target pixel. Here, with the use of bi-phase clock signals, the target pixel is pre-charged with a data signal supplied to a pixel which is located two lines away from the target pixel. FIG. 7 illustrates a case (pattern 2) where the liquid crystal display device 1 is subjected to the AC driving employing a dot inversion technique. In this case, it is always possible to pre-charge the target pixel by the data signal supplied to the pixel having the same color as the target pixel. Here, with the use of the bi-phase clock signals, the target pixel is pre-charged with the data signal supplied to the pixel which is located two lines away from the target pixel. FIG. 8 illustrates a case (pattern 3) where the liquid crystal display device 1 is subjected to the AC driving employing a source line inversion technique. In this case, (i) it is always possible to pre-charge the target pixel by the data signal supplied to the pixel having the same color as the target pixel, and (ii) data signals supplied to the pixels connected to the same source line have the same polarity. Here, the target pixel is pre-charged with a data signal supplied to a pixel which is located one line away from the target pixel. Further, in this case, in order to drive the gate driver, it is possible to use either the bi-phase clock signals or a single clock signal.

Each of FIGS. 9 through 13 shows a relationship between the pre-charging and the main-charging in a case where the driving with the use of tri-phase clock signals in accordance with the present invention is applied.

FIG. 9 illustrates a case (pattern 4) in which (i) each of the plurality of gate lines GL is connected to part of the plurality of pixels PIX correspondingly such that an array unit in which an R pixel, a G pixel, and a B pixel are arranged in this order is repeated along each of the plurality of gate lines GL, and simultaneously (ii) each of the plurality of source lines SL is connected to part of the plurality of pixels PIX correspondingly such that an array unit in which an R pixel, a B pixel, and a G pixel are arranged in this order is repeated along each of the plurality of source lines SL. The present invention is applicable to the pattern 4. In FIG. 9, the plurality of pixels PIX are subjected to the AC driving employing the source line inversion technique. For this reason, the target pixel can be pre-charged with a data signal supplied to a pixel which is located three lines before the target pixel.

FIG. 10 illustrates a case (pattern 5) in which (i) each of the plurality of gate lines GL is connected to part of the plurality of pixels PIX correspondingly such that the pixels having the same color are arranged along each of the plurality of gate lines GL, and simultaneously (ii) each of the plurality of source lines SL is connected to part of the plurality of pixels PIX correspondingly such that an array unit in which an R pixel, a B pixel, and a G pixel are arranged in this order is repeated along each of the plurality of source lines SL. The present invention is applicable to the pattern 5. In FIG. 10, the plurality of pixels PIX are subjected to the AC driving employing the source line inversion technique. For this reason, the target pixel can be pre-charged with a data signal supplied to a pixel which is located three lines before the target pixel.

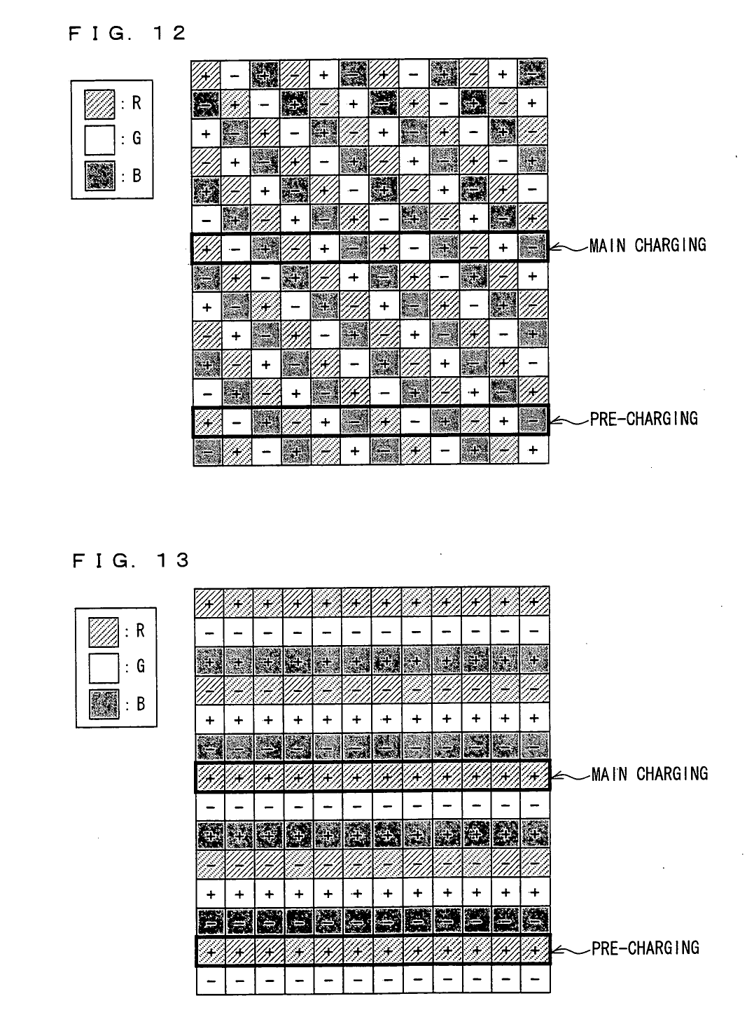

FIG. 11 illustrates a case (pattern 6) in which (i) each of the plurality of gate lines GL is connected to part of the plurality of pixels PIX correspondingly such that the pixels having the same color are arranged along each of the plurality of pixels PIX, and simultaneously (ii) each of the plurality of source lines SL is connected to part of the plurality of pixels PIX correspondingly such that an array unit in which an R pixel, a B pixel, and a G pixel are arranged in this order is repeated along each of the plurality of source lines SL. The present invention is applicable to the pattern 6. In FIG. 11, the plurality of pixels PIX are subjected to the gate line inversion such that the gate line inversion is carried out every four gate lines GL. Further, the plurality of pixels PIX are subjected to the AC driving employing the source line inversion technique. For this reason, the target pixel can be pre-charged with a data signal supplied to a pixel which is located six lines before the target pixel.

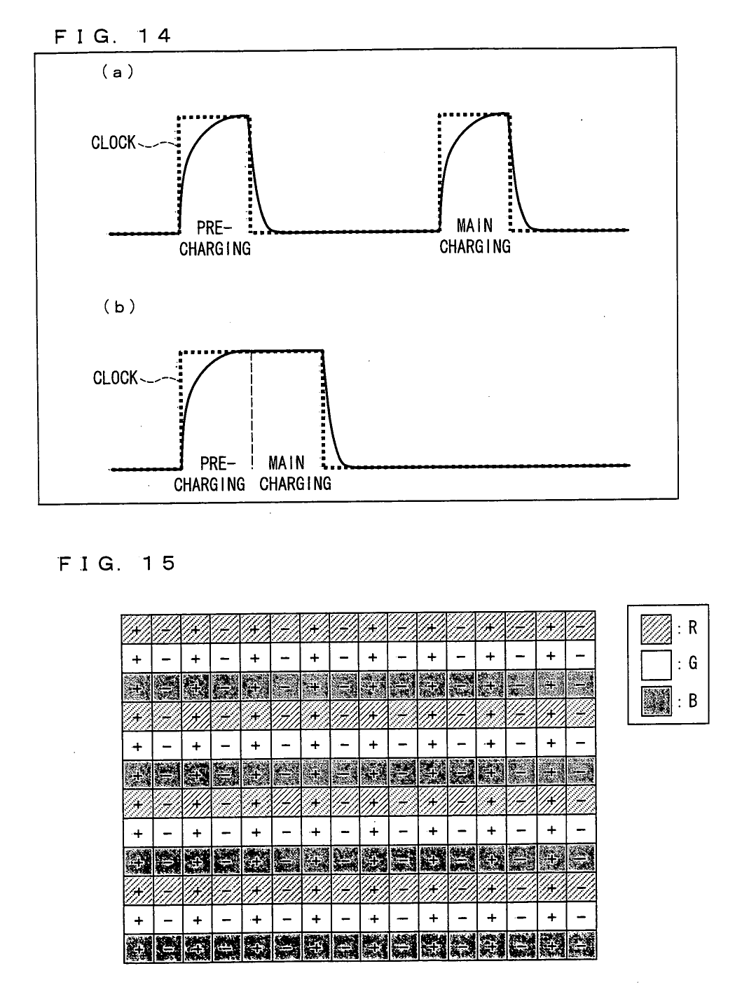

FIG. 12 illustrates a case (pattern 7) in which (i) each of the plurality of gate lines GL is connected to part of the plurality of pixels PIX correspondingly such that an array unit in which an R pixel, a G pixel, and a B pixel are arranged in this order is repeated along each of the plurality of gate lines GL, and simultaneously (ii) each of the plurality of source lines SL is connected to part of the plurality of pixels PIX correspondingly such that an array unit in which an R pixel, a B pixel, and a G pixel are arranged in this order is repeated along each of the plurality of source lines SL. The present invention is applicable to the pattern 7. In FIG. 12, the plurality of pixels PIX are subjected to the AC driving by the dot inversion method. For this reason, the target pixel can be pre-charged with a data signal supplied to a pixel which is located six lines before the target pixel.

FIG. 13 illustrates a case (pattern 8) in which (i) each of the plurality of gate lines GL is connected to part of the plurality of pixels PIX correspondingly such that the pixels having the same color are arranged along each of the plurality of gate lines GL, and simultaneously (ii) each of the plurality of source lines SL is connected to part of the plurality of pixels PIX correspondingly such that an array unit in which an R pixel, a B pixel, and a G pixel are arranged in this order is repeated along each of the plurality of source lines SL. The present invention is applicable to the pattern 8. In FIG. 13, the plurality of pixels PIX are subjected to the AC driving employing the gate line inversion technique. For this reason, the target pixel can be pre-charged with a data signal supplied to a pixel which is located six lines before the target pixel.

Further, in a case where the plurality of pixels PIX shown in any of FIGS. 9 through 13 are driven by two gate drivers, as in the liquid crystal display device 11, the target pixel can be pre-charged with the data signal supplied to the pixel which is located six lines before the target pixel.

The following Table 1 shows, for each of the above patterns, a minimum distance (unit of distance: pixel) between the target pixel of the pre-charging and the pixel receiving the data signal which can be used to pre-charge the target pixel. Note that Table 1 also shows a minimum distance (unit of distance: pixel) in a case where each of the above patterns (see FIGS. 9 through 13) is driven by conventional bi-phase clock signals. In Table 1, “One-sided Driving” represents the driving carried out by a single gate driver, and “Two-sided Driving” represents the driving carried out by two gate drivers.

TABLE 1

| | Bi-phase | | | |
|---|---|---|---|---|
| | Clock Signals | | Tri-phase | |
| | (Conventional | | Clock Signals | |
| | Technique) | | (Present Invention) | |
| Pixel | One-sided | Two-sided | One-sided | Two-sided |
| Arrangement | Driving | Driving | driving | Driving |
| Pattern 1 | 4 | 4 | — | — |
| Pattern 2 | 4 | 4 | — | — |
| Pattern 3 | 4 | 4 | — | — |
| Pattern 4 | 6 | 12 | 3 | 6 |
| Pattern 5 | 6 | 12 | 3 | 6 |
| Pattern 6 | 6 | 12 | 6 | 6 |
| Pattern 7 | 6 | 12 | 6 | 6 |
| Pattern 8 | 6 | 12 | 6 | 6 |

Note that either in the driving method of FIG. 1 or in the driving method of FIG. 2, it is possible that any of the GSP, GSP1, and GSP2 has two or more pulses for the pre-charging so as to have a total of three or more pulses (including the pulse for the main-charging).

For example, in the display region 2a of FIG. 9 or 10, the target pixel is pre-charged with the data signal supplied to the pixel which has the same color and the same polarity as the target pixel and is located three lines before the target pixel. In this case, it is possible to carry out the pre-charging several times by use of the data signal(s) which has (have) the same color and the same polarity as the target pixel and is (are) located 6 and/or 9 lines before the target pixel. With the arrangement, even if a period for pre-charging the target pixel with the use of a single data signal is insufficient, the target pixel can be pre-charged several times by the data signals supplied to the pixels having the same color and the same polarity as the target pixel. Therefore, the target pixel can be sufficiently pre-charged. This technique is particularly effective and suitable for a case where the display region 2a is subjected to the AC driving and the data signal supplied in the previous frame has a polarity opposite to that of the data signal supplied in the current frame. This is because, in such a case, it takes longer for pre-charging the target pixel due to polarity inversion. Further, the technique is also particularly effective and suitable for a case where the display device is used in a cryogenic environment. This is because, in such an environment, it takes longer for pre-charging the target pixel due to a high ON resistance of the TFT. By merely adopting the arrangement illustrated in FIG. 4 or 5, in which each gate driver receives three clock signals, it is possible to easily pre-charge the target pixel several times by use of the data signals having the same color and the same polarity as the target pixel.

Further, for inversion of the polarity of the data signal in the previous frame, it is possible to use not only the data signal supplied to the pixel which has the same color and the same polarity as the target pixel but also a data signal supplied to a pixel which has the same polarity as the target pixel but is different in color from the target pixel. For example, in a case where the pre-charging with respect to the target pixel is completed by the data signal supplied to the pixel located three lines before the target pixel, it is possible to pre-charge the target pixel by a data signal supplied to a pixel located four or five lines before the target pixel so as to carry out the polarity inversion. This allows the target pixel to be sufficiently pre-charged with the data signal supplied to the pixel located three lines before the target pixel, i.e. the target pixel is pre-charged to an electric potential which is sufficiently close to that of the data signal for main-charging the target pixel.

Thus, by pre-charging the target pixel several times, it is possible to improve the display quality. It is possible to carry out the pre-charging several times (i) with respect to the display region 2a illustrated in any of FIGS. 11 through 13. Further, it is also possible to carry out the pre-charging either in the case of the one-sided driving or in the case of the two-sided driving.

As described above, according to the present embodiment, it is possible to realize a display device which can pre-charge, with a simple arrangement, a target pixel with an electric potential which is close to that of a data signal for charging the target pixel, in a panel in which a plurality of first color pixels, a plurality of second color pixels, and a plurality of third color pixels are arranged so as to alternate with one another along a direction in which a plurality of data signal lines extend.

In the above examples, the clock pulses of the first, second, and third clock signals do not overlap each other, and the clock pulses of the fourth, fifth, and sixth clock signals do not overlap each other. Note, however, that it is self-evident that these clock signals can be used in a circuit as signals for merely indicating input timing, such as rise-up timing. Accordingly, the clock pulses can overlap each other. In the same manner, the clock pulse of the first clock signal can be overlapped with the clock pulse of the fourth clock signal and/or the clock pulse of the sixth clock signal with each other, the clock pulse of the second clock signal can be overlapped with the clock pulse of the fourth clock signal and/or the clock pulse of the fifth clock signal with each other, and the clock pulse of the third clock signal can be overlapped with the clock pulse of the fifth clock signal and/or the clock pulse of the sixth clock signal.

Further, each of the gate drivers 5, 15a, and 15b can be realized in the form of IC.

Next, the following description deals with a reference embodiment of the present invention.

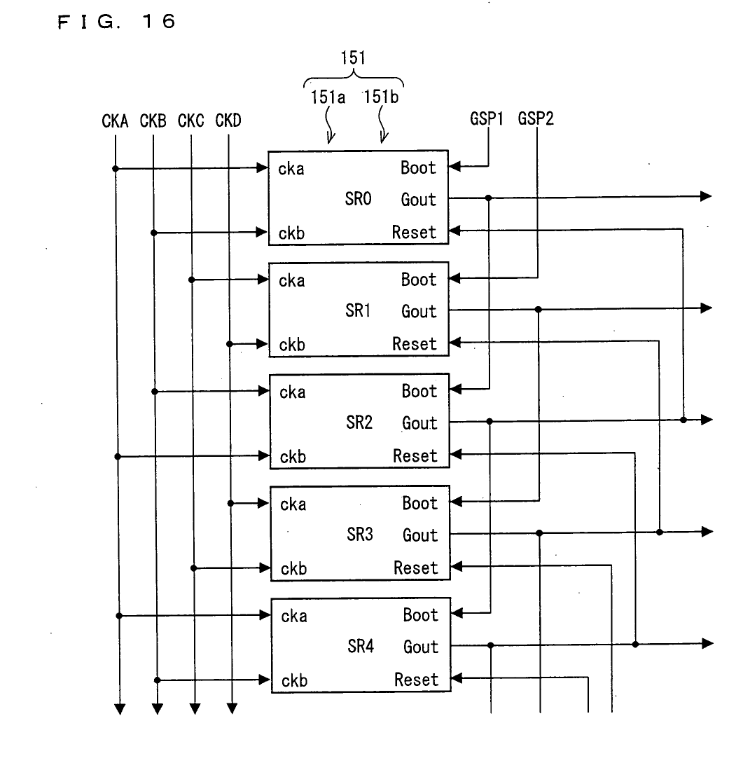

A reduction in charging efficiency and an increase in power consumption may be caused due to frequent rises and falls of the clock (see (a) of FIG. 14). In the present reference embodiment, the pre-charging and the main-charging are successively carried out (see (b) of FIG. 14) so that the above problems can be avoided.

In the present reference embodiment, the panel has the arrangement of FIG. 15, in which (i) each of the plurality of gate lines is connected to part of the plurality of pixels correspondingly such that the pixels having the same color are arranged along each of the plurality of gate lines, and simultaneously (ii) each of the plurality of source lines is connected to part of the plurality of pixels correspondingly such that an array unit in which an R pixel, a G pixel, and a B pixel are arranged in this order is repeated along each of the plurality of source lines. The panel is driven by the source line inversion method.

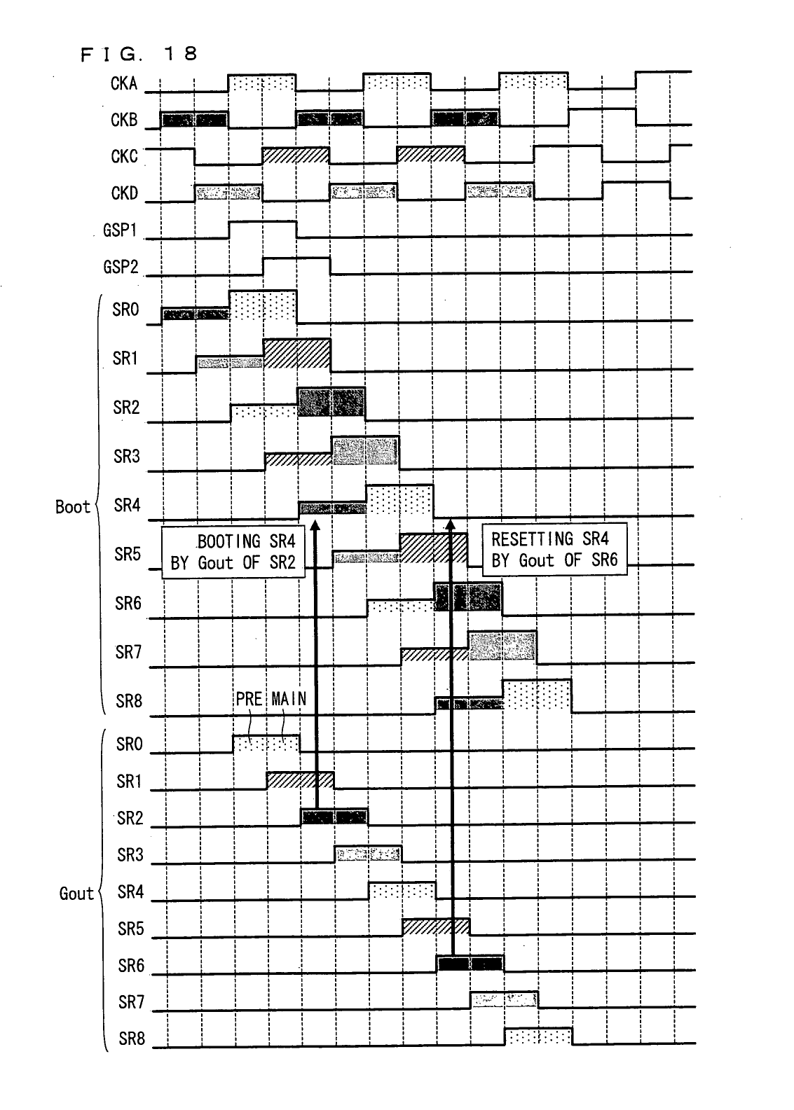

FIG. 16 illustrates an arrangement of a gate driver 151 of the present reference embodiment.

The gate driver 151 includes: a first shift register 151a in which a plurality of shift register stages SR (SR0, SR2, SR4 . . . ) are provided such that neighboring shift register stages SR are connected to each other; and a second shift register 151b in which a plurality of shift register stages SR (SR1, SR3, SR5 . . . ) are connected in cascade.

Each of the shift register stages SR of the first shift register 151a includes: a set input terminal Boot; an output terminal Gout; a reset input terminal Reset; clock input terminals cka and ckb; and a clear terminal clr. Note that the clear terminal clr is omitted in FIG. 16 since it is the same as the ones illustrated in (b) of FIG. 4 and (b) of FIG. 5. The first shift register 151a receives, from a control substrate, clock signals CKA and CKB, a gate start pulse GSP1, and a low electric potential power source.

The ith (i=0, 2, 4 . . . ) gate line GLi receives a gate output Gi from the output terminal Gout of the jth (j=1, 2, 3 . . . , j=i/2+1) shift register SRi of the first shift register 151a.

The first (with regard to “j”) shift register SR0, i.e. an endmost stage in a scanning direction, receives the gate start pulse GSP1 via its input terminal Boot, while each subsequent shift register stage SRi receives a gate output Gi−2 from a preceding shift register stage SRi−2. Further, each shift register stage SRi receives, via its reset input terminal Reset, a gate output Gi+2 from a subsequent shift register stage SRi+2.

The first (with regard to “j”) shift register stage SR0 receives the clock signal CKA via its clock input terminal cka, and the clock signal CKB via its clock input terminal ckb. The same goes for the shift register stages (first stages) SR located every two shift register stages SR from the shift register stage SR0. The second (with regard to “j”) shift register stage SR2 receives the clock signal CKB via its clock input terminal cka, and the clock signal CKA via its clock input terminal ckb. The same goes for the shift register stages (second stages) SR located every two shift register stages from the shift register stage SR2. As described above, the first and second stages are arranged so as to alternate with each other in the first shift register 151a.

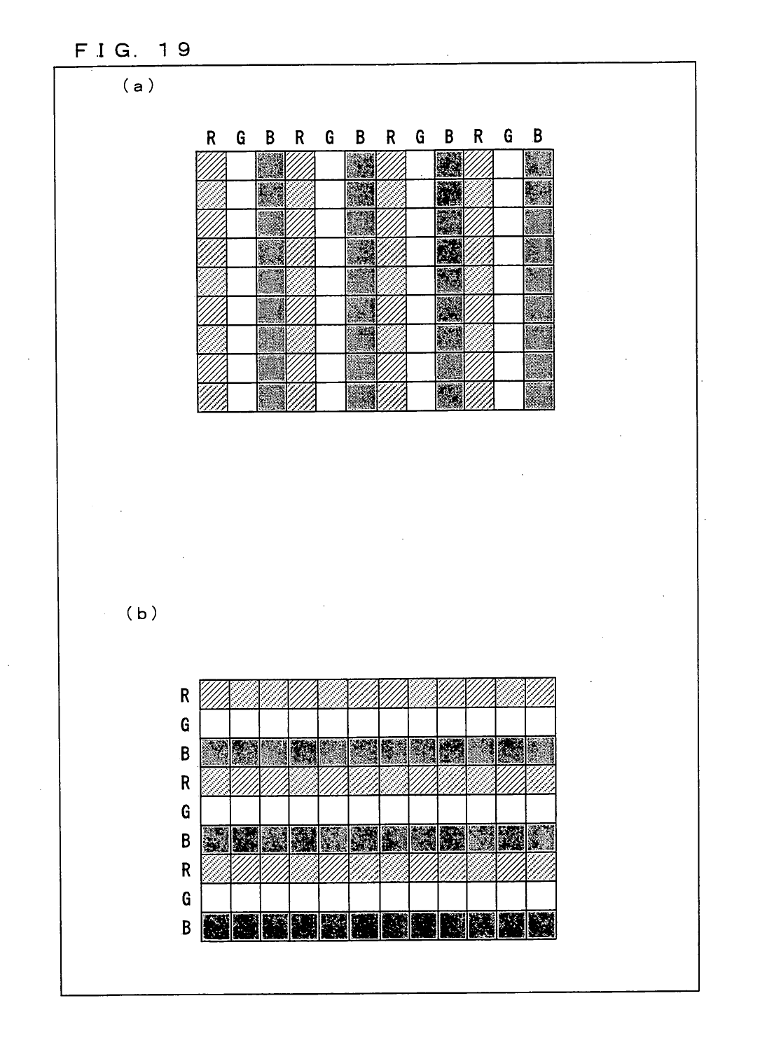

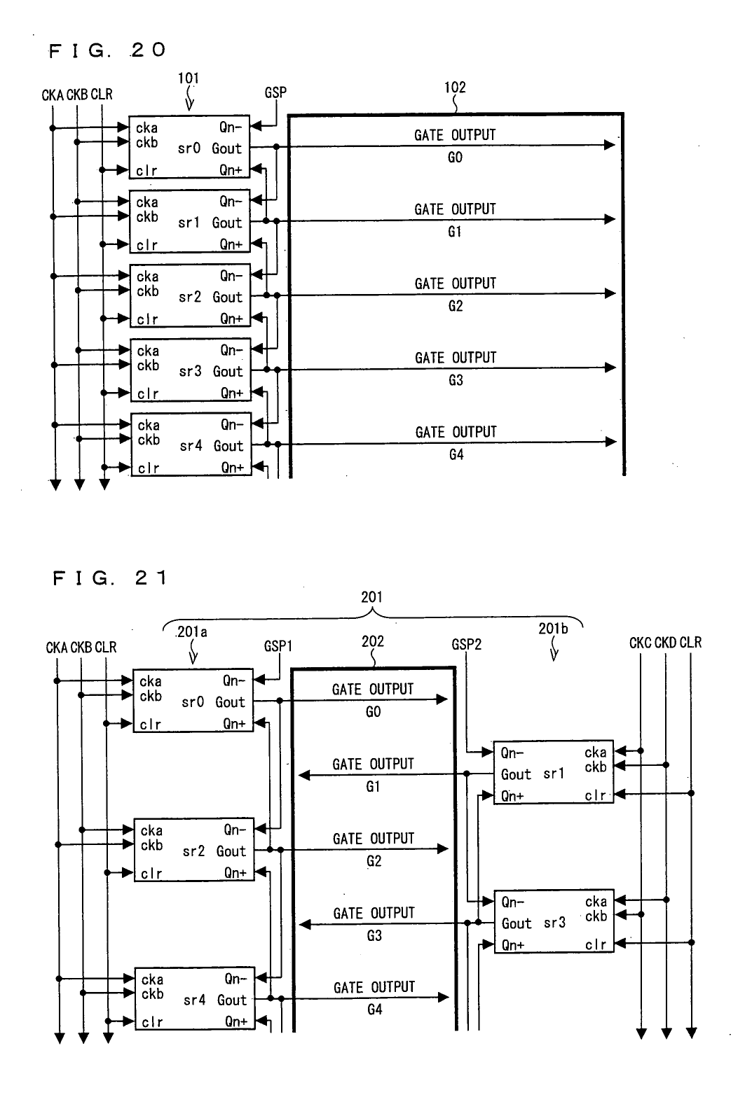

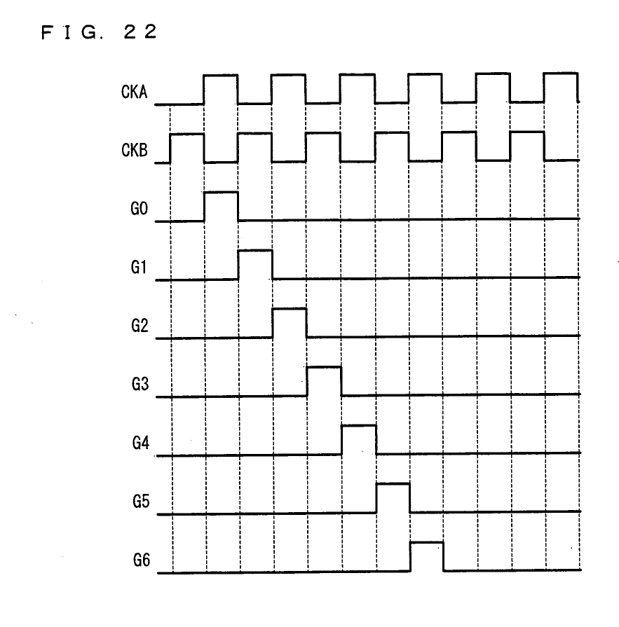

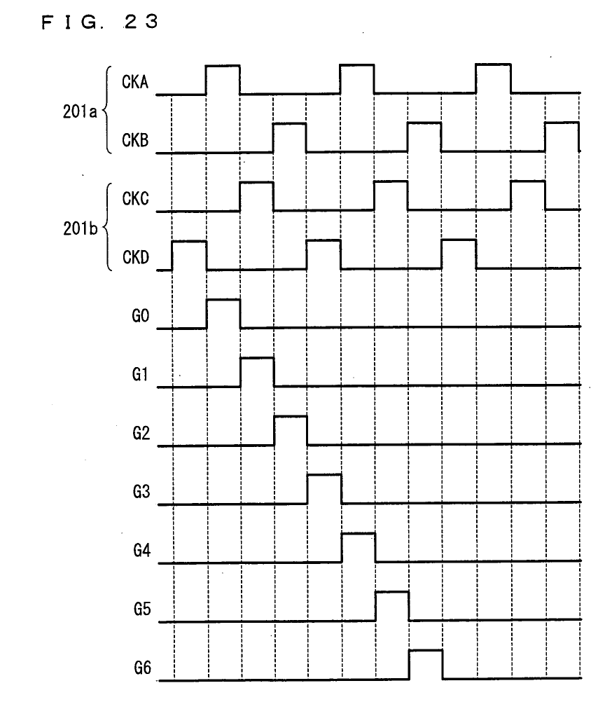

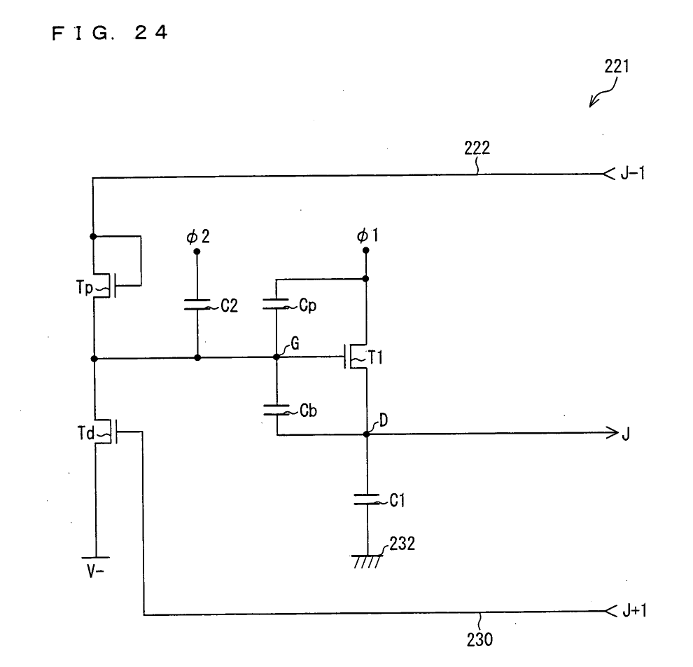

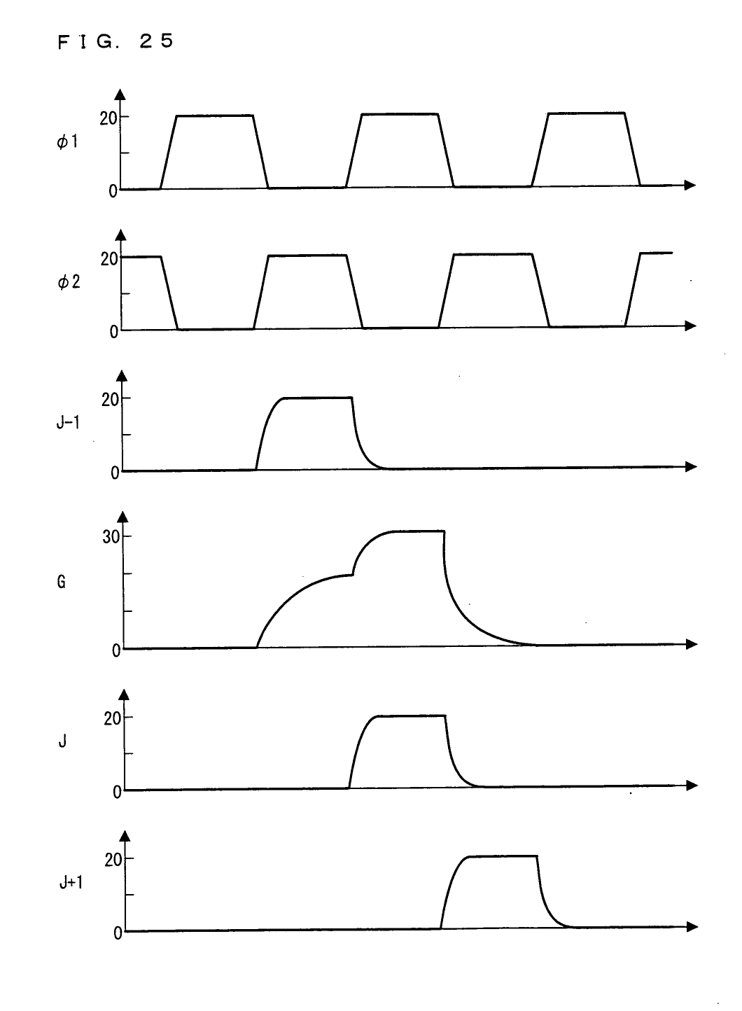

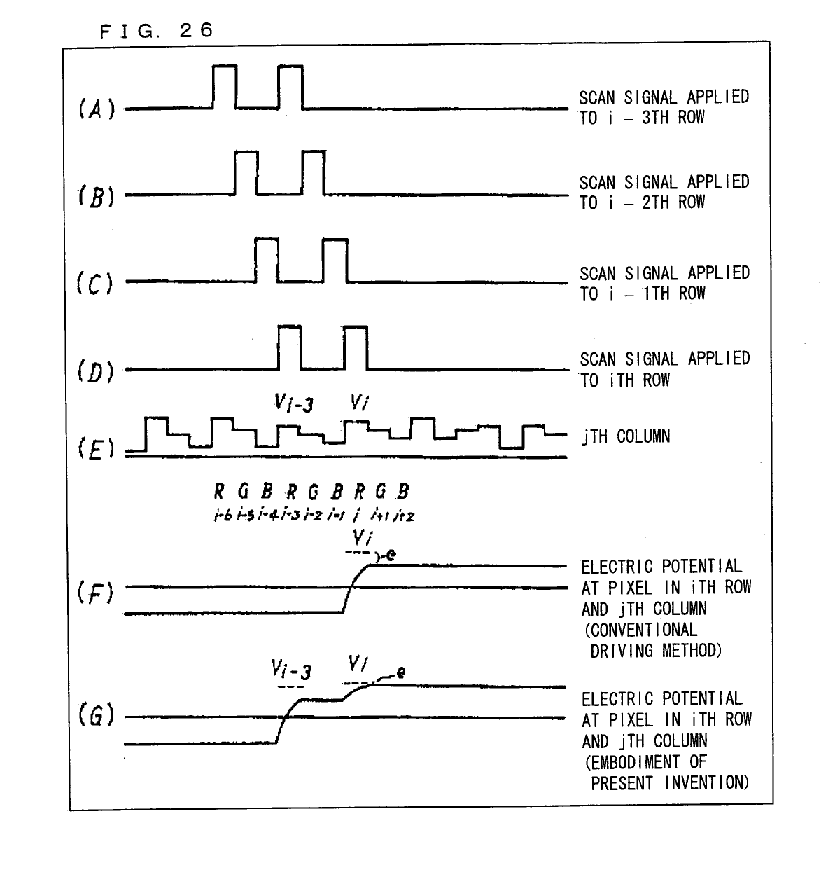

The clock signals CKA and CKB have waveforms shown in FIG. 18, respectively. The clock signals CKA and CKB have phases opposite to each other so that clock pulses of the clock signals CKA and CKB do not overlap each other. The clock pulse of the clock signal CKB is followed by the clock pulse of the clock signal CKA, and vice versa.

Further, each of the shift register stages SR of the second shift register 151b includes: the set input terminal Boot; the output terminal Gout; the reset input terminal Reset; the clock input terminals cka and ckb; and the clear terminal clr. Here, the clear terminal clr is omitted in FIG. 16 in the same manner as described above. The second shift register 151b receives, from the control substrate, clock signals CKC and CKD, a gate start pulse GSP2, and a low electric potential power source.

The ith (i=1, 3, 5 . . . ) gate line GLi receives a gate output Gi from the output terminal Gout of the kth (k=1, 2, 3 . . . , k=(i+1)/2) shift register stage SRi of the second shift register 151b.

The first (with regard to “k”) shift register stage SR1, i.e. an endmost stage in the scanning direction, receives the gate start pulse GSP2 via its input terminal Boot, while each subsequent shift register stage SRi receives a gate output Gi−2 from a preceding shift register stage SRi−2. Further, each shift register stage SRi receives, via its reset input terminal Reset, a gate output Gi+2 from a subsequent shift register stage SRi+2.

The first (with regard to “k”) shift register stage SR1 receives the clock signal CKC via its clock input terminal cka, and the clock signal CKD via its clock input terminal ckb. The same goes for the shift register stages (third stages) SR located every two shift register stages from the shift register stage SR1. The second (with regard to “k”) shift register stage SR3 receives the clock signal CKD via its clock input terminal cka, and the clock signal CKC via its clock input terminal ckb. The same goes for the shift register stages (fourth stages) SR located every two shift register stages from the shift register stage SR3. As described above, the third stages and fourth stages are arranged so as to alternate with each other in the second shift register 151b.

The clock signals CKC and CKD have waveforms shown in FIG. 18, respectively. The clock signals CKC and CKD have phases opposite to each other so that the clock pulses of the clock signals CKC and CKD do not overlap each other. The clock pulse of the clock signal CKD is followed by the clock pulse of the clock signal CKC, and vice versa.

Further, as shown in FIG. 18, the clock signals CKA, CKB, CKC, and CKD are such that (i) the clock pulse of the clock signal CKD overlaps the clock pulse of the clock signal CKA with each other, and is followed by the clock pulse of the clock signal CKA, (ii) the clock pulse of the clock signal CKA overlaps the clock pulse of the clock signal CKC with each other, and is followed by the clock pulse of the clock signal CKC, (iii) the clock pulse of the clock signal CKC overlaps the clock pulse of the clock signal CKB with each other, and is followed by the clock pulse of the clock signal CKB, and (iv) the clock pulse of the clock signal CKB overlaps the clock pulse of the clock signal CKD with each other, and is followed by the clock pulse of the clock signal CKD.

The gate start pulse GSP1 overlaps the gate start pulse GSP2 with each other, and is followed by the gate start pulse GSP2 (see FIG. 18). The gate start pulse GSP1 has a pulse synchronized with the clock pulse of the clock signal CKA, while the gate start pulse GSP2 has a pulse synchronized with the clock pulse of the clock signal CKC.

Each of the shift register stages SR has a modified arrangement of FIG. 3, in which no clock input terminal ckc is provided and the gate of the transistor M is connected to the clock input terminal ckb.

With the arrangement, the gate output is supplied to each gate line Gi by use of a quadri-phase clock signals constituted by the clock signals CKA, CKB, CKC, and CKD. The target pixel is pre-charged during a first half of the gate pulse by a data signal for main-charging a pixel located in the upstream of the target pixel, and is main-charged during a last half of the gate pulse by a data signal for charging the target pixel (see the timing chart of FIG. 18).

This reduces the number of times that each of the plurality of gate lines is charged and discharged. Thereby, it is possible to have an improvement in charging efficiency and a reduction in power consumption.

The present invention is not limited to the description of the embodiments above, but may be altered by a skilled person within the scope of the claims. An embodiment based on a proper combination of technical means disclosed in different embodiments is encompassed in the technical scope of the present invention. The present invention is also applicable to an EL display device, for example.

As described above, a display device of the present invention includes a scan signal line driving circuit which receives a first clock signal, a second clock signal, and a third clock signal, the first clock signal, the second clock signal, and the third clock signal being such that (i) a clock pulse of the third clock signal is followed by a clock pulse of the first clock signal, (ii) the clock pulse of the first clock signal is followed by a clock pulse of the second clock signal, and (iii) the clock pulse of the second clock signal is followed by the clock pulse of the third clock signal, the scan signal line driving circuit including a shift register having a plurality of stages which are aligned in a scanning direction, the shift register receiving a shift pulse at one endmost stage thereof and shifting the shift pulse from the one endmost stage thereof to the other endmost stage thereof stage by stage in accordance with each of clock pulses of the first clock signal, the second clock signal, and the third clock signal, sequentially received by the scan signal line driving circuit, each of the plurality of stages supplying a scan pulse to a corresponding one of a plurality of scan signal lines in accordance with the shift pulse inputted to that stage by the shifting.

Further, as described above, a display device of the present invention includes: a first scan signal line driving circuit which receives a first clock signal, a second clock signal, and a third clock signal, the first scan signal line driving circuit being connected to a plurality of first scan signal lines among a plurality of scan signal lines; and a second scan signal line driving circuit which receives a fourth clock signal, a fifth clock signal, and a sixth clock signal, the second scan signal line driving circuit being connected to a plurality of second scan signal lines which are scan signal lines other than the plurality of first scan signal lines among the plurality of scan signal lines, the plurality of first scan signal lines and the plurality of second scan signal lines being arranged so as to alternate with each other, the first clock signal, the second clock signal, the third clock signal, the fourth clock signal, the fifth clock signal, and the sixth clock signal being such that (i) a clock pulse of the sixth clock signal is followed by a clock pulse of the first clock signal, (ii) the clock pulse of the first clock signal is followed by a clock pulse of the fourth clock signal, (iii) the clock pulse of the fourth clock signal is followed by a clock pulse of the second clock signal, (iv) the clock pulse of the second clock signal is followed by a clock pulse of the fifth clock signal, (v) the clock pulse of the fifth clock signal is followed by a clock pulse of the third clock signal, (vi) the clock pulse of the third clock signal is followed by the clock pulse of the sixth clock signal, the first scan signal line driving circuit including a first shift register having a plurality of stages which are aligned in a scanning direction, the first shift register receiving a first shift pulse at one endmost stage thereof and shifting the first shift pulse from the one endmost stage thereof to the other endmost stage thereof stage by stage in accordance with each of clock pulses of the first clock signal, the second clock signal, and the third clock signal, sequentially received by the first scan signal line driving circuit, each of the plurality of stages supplying a scan pulse to a corresponding one of the plurality of first scan signal lines in accordance with the first shift pulse inputted to that stage by the shifting, the second scan signal line driving circuit including a second shift register having a plurality of stages which are aligned in the scanning direction, the second shift register receiving a second shift pulse at one endmost stage thereof and shifting the second shift pulse from the one endmost stage thereof to the other endmost stage thereof stage by stage in accordance with each of clock pulses of the fourth clock signal, the fifth clock signal, and the sixth clock signal, sequentially received by the second scan signal line driving circuit, each of the plurality of stages supplying a scan pulse to a corresponding one of the plurality of second scan signal lines in accordance with the second shift pulse inputted to that stage by the shifting.

Therefore, it is possible to realize a display device which can pre-charge a target pixel with an electric potential which is close to that of a data signal for charging the target pixel, in a panel in which a plurality of first color pixels, a plurality of second color pixels, a plurality of third color pixels are arranged so as to alternate with one another along a direction in which a plurality of data signal lines extend.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is suitably applicable to, particularly, a liquid crystal display device.

1. A display device comprising:
an active matrix panel including (i) a plurality of pixels including a plurality of first color pixels, a plurality of second color pixels, and a plurality of third color pixels, and (ii) a plurality of data signal lines, each of which is connected with part of the plurality of pixels correspondingly, such that an array unit, in which one first color pixel, one second color pixel, and one third color pixel are arranged in a predetermined order along a direction in which the plurality of data signal lines extend, is repeated along each of the plurality of data signal lines; and
a scan signal line driving circuit which receives a first clock signal, a second clock signal, and a third clock signal,
the first clock signal, the second clock signal, and the third clock signal being such that (i) a clock pulse of the third clock signal is followed by a clock pulse of the first clock signal, (ii) the clock pulse of the first clock signal is followed by a clock pulse of the second clock signal, and (iii) the clock pulse of the second clock signal is followed by the clock pulse of the third clock signal,
the scan signal line driving circuit including a shift register having a plurality of stages which are aligned in a scanning direction,
the shift register receiving a shift pulse at one endmost stage thereof and shifting the shift pulse from the one endmost stage thereof to the other endmost stage thereof stage by stage in accordance with each of clock pulses of the first clock signal, the second clock signal, and the third clock signal, sequentially received by the scan signal line driving circuit,
each of the plurality of stages supplying a scan pulse to a corresponding one of a plurality of scan signal lines in accordance with the shift pulse inputted to that stage by the shifting.

2. A display device comprising:
an active matrix panel including (i) a plurality of pixels including a plurality of first color pixels, a plurality of second color pixels, and a plurality of third color pixels, and (ii) a plurality of data signal lines, each of which is connected with part of the plurality of pixels correspondingly, such that an array unit, in which one first color pixel, one second color pixel, and one third color pixel are arranged in a predetermined order along a direction in which the plurality of data signal lines extend, is repeated along each of the plurality of data signal lines;
a first scan signal line driving circuit which receives a first clock signal, a second clock signal, and a third clock signal, the first scan signal line driving circuit being connected to a plurality of first scan signal lines among a plurality of scan signal lines; and
a second scan signal line driving circuit which receives a fourth clock signal, a fifth clock signal, and a sixth clock signal, the second scan signal line driving circuit being connected to a plurality of second scan signal lines which are scan signal lines other than the first scan signal lines among the plurality of scan signal lines,
the plurality of first scan signal lines and the plurality of second scan signal lines being arranged so as to alternate with each other,
the first clock signal, the second clock signal, the third clock signal, the fourth clock signal, the fifth clock signal, and the sixth clock signal being such that (i) a clock pulse of the sixth clock signal is followed by a clock pulse of the first clock signal, (ii) the clock pulse of the first clock signal is followed by a clock pulse of the fourth clock signal, (iii) the clock pulse of the fourth clock signal is followed by a clock pulse of the second clock signal, (iv) the clock pulse of the second clock signal is followed by a clock pulse of the fifth clock signal, (v) the clock pulse of the fifth clock signal is followed by a clock pulse of the third clock signal, (iv) the clock pulse of the third clock signal is followed by the clock pulse of the sixth clock signal,
the first scan signal line driving circuit including a first shift register having a plurality of stages which are aligned in a scanning direction,
the first shift register receiving a first shift pulse at one endmost stage thereof and shifting the first shift pulse from the one endmost stage thereof to the other endmost stage thereof stage by stage in accordance with each of clock pulses of the first clock signal, the second clock signal, and the third clock signal, sequentially received by the first scan signal line driving circuit,
each of the plurality of stages of the first shift register supplying a scan pulse to a corresponding one of the plurality of first scan signal lines in accordance with the first shift pulse inputted to that stage by the shifting,
the second scan signal line driving circuit including a second shift register having a plurality of stages which are aligned in the scanning direction,
the second shift register receiving a second shift pulse at one endmost stage thereof and shifting the second shift pulse from the one endmost stage thereof to the other endmost stage thereof stage by stage in accordance with each of clock pulses of the fourth clock signal, the fifth clock signal, and the sixth clock signal, sequentially received by the second scan signal line driving circuit,
each of the plurality of stages of the second shift register supplying the scan pulse to a corresponding one of the plurality of second scan signal lines in accordance with the second shift pulse inputted to that stage by the shifting.

3. The display device as set forth in claim 1, wherein:
the scan signal line driving circuit is monolithically formed in the active matrix panel.

4. The display device as set forth in claim 2, wherein:
each of the first scan signal line driving circuit and the second scan signal line driving circuit is monolithically formed in the active matrix panel.

5. The display device as set forth in claim 1, wherein:
in a single frame, data signals of different polarities are supplied to adjacent ones of the plurality of data signal lines, so that, among the plurality of pixels, pixels connected to one data signal line receives data signals of one polarity and pixels connected to data signal lines adjacent to the one data signal line receive data signals of the other polarity.

6. The display device as set forth in claim 1, wherein:
the plurality of scan signal lines are independently connected with pixels of one color among the plurality of first color pixels, the plurality of second color pixels, and the plurality of third color pixels.

7. The display device as set forth in claim 1, wherein:
the plurality of scan signal lines are independently connected with pixels of different colors among the plurality of first color pixels, the plurality of second color pixels, and the plurality of third color pixels, in such a manner that pixels adjacently connected to a same scan signal line are of different colors.

8. The display device as set forth in claim 1, wherein:
the active matrix panel is formed by use of amorphous silicon.

9. The display device as set forth in claim 1, wherein:
the active matrix panel is formed by use of polycrystalline silicon.

10. The display device as set forth in claim 1, wherein:
the active matrix panel is formed by use of CG silicon.

11. The display device as set forth in claim 1, wherein:
the active matrix panel is formed by use of microcrystalline silicon.

12. A method for driving a display device,
the display device including:
an active matrix panel including (i) a plurality of pixels including a plurality of first color pixels, a plurality of second color pixels, and a plurality of third color pixels, and (ii) a plurality of data signal lines, each of which is connected with part of the plurality of pixels correspondingly, such that an array unit, in which one first color pixel, one second color pixel, and one third color pixel are arranged in a predetermined order along a direction in which the plurality of data signal lines extend, is repeated along each of the plurality of data signal lines; and
a scan signal line driving circuit having a plurality of stages which are aligned in a scanning direction,
the method comprising the steps of:
supplying a first clock signal, a second clock signal, and a third clock signal to the scan signal line driving circuit; and
causing the scan signal line driving circuit to carry out a shift register operation,
the first clock signal, the second clock signal, and the third clock signal being such that (i) a clock pulse of the third clock signal is followed by a clock pulse of the first clock signal, (ii) the clock pulse of the first clock signal is followed by a clock pulse of the second clock signal, and (iii) the clock pulse of the second clock signal is followed by the clock pulse of the third clock signal,
the shift register operation including (i) receiving a shift pulse at one endmost stage of the shift register, (ii) shifting the shift pulse from the one endmost stage to the other endmost stage of the shift register stage by stage, in accordance with each of clock pulses of the first clock signal, the second clock signal, and the third clock signal, sequentially received by the scan signal line driving circuit, and (iii) causing each of the plurality of stages to supply a scan pulse to a corresponding one of a plurality of scan signal lines in accordance with the shift pulse inputted to that stage by the shifting.

13. A method for driving a display device,
the display device including:
an active matrix panel including (i) a plurality of pixels including a plurality of first color pixels, a plurality of second color pixels, and a plurality of third color pixels, and (ii) a plurality of data signal lines, each of which is connected with part of the plurality of pixels correspondingly, such that an array unit, in which one first color pixel, one second color pixel, and one third color pixel are arranged in a predetermined order along a direction in which the plurality of data signal lines extend, is repeated along each of the plurality of data signal lines;
a first scan signal line driving circuit connected to a plurality of first scan signal lines among a plurality of scan signal lines, the first scan signal line driving circuit having a plurality of stages which are aligned in a scanning direction; and
a second scan signal line driving circuit connected to a plurality of second scan signal lines which are scan signal lines other than the plurality of first scan signal lines among the plurality of scan signal lines, the second scan signal line driving circuit having a plurality of stages which are aligned in the scanning direction,
the plurality of first scan signal lines and the plurality of second scan signal lines being arranged so as to alternate with each other,
the method comprising the steps of:
supplying a first clock signal, a second clock signal, and a third clock signal to the first scan signal line driving circuit;
supplying a fourth clock signal, a fifth clock signal, and a sixth clock signal to the second scan signal line driving circuit;
causing the first shift register to carry out a first shift register operation; and
causing the second shift register to carry out a second shift register operation,
the first clock signal, the second clock signal, the third clock signal, the fourth clock signal, the fifth clock signal, and the sixth clock signal being such that (i) a clock pulse of the sixth clock signal is followed by a clock pulse of the first clock signal, (ii) the clock pulse of the first clock signal is followed by a clock pulse of the fourth clock signal, (iii) the clock pulse of the fourth clock signal is followed by a clock pulse of the second clock signal, (iv) the clock pulse of the second clock signal is followed by a clock pulse of the fifth clock signal, (v) the clock pulse of the fifth clock signal is followed by a clock pulse of the third clock signal, (iv) the clock pulse of the third clock signal is followed by the clock pulse of the sixth clock signal,
the first shift register operation including: (i) receiving a first shift pulse at one endmost stage of the first shift register; (ii) shifting the first shift pulse from the one endmost stage of the first shift register to the other endmost stage of the first shift register stage by stage in accordance with each of clock pulses of the first clock signal, the second clock signal, and the third clock signal, sequentially received by the first scan signal line driving circuit; and (iii) causing each of the plurality of stages of the first shift register to supply a scan pulse to a corresponding one of the plurality of first scan signal lines in accordance with the first shift pulse inputted to that stage by the shifting,
the second shift register operation including: (i) receiving a second shift pulse at one endmost stage of the second shift register; (ii) shifting the second shift pulse from the one endmost stage of the second shift register to the other endmost stage of the second shift register stage by stage in accordance with each of clock pulses of the fourth clock signal, the fifth clock signal, and the sixth clock signal, sequentially received by the second scan signal line driving circuit; and (iii) causing each of the plurality of stages of the second shift register to supply a scan pulse to a corresponding one of the plurality of second scan signal lines in accordance with the second shift pulse inputted to that stage by the shifting.

14. A scan signal line driving circuit comprising:
a shift register having a plurality of stages which are aligned in a scanning direction,
the scan signal line driving circuit receiving a first clock signal, a second clock signal, and a third clock signal,
the first clock signal, the second clock signal, and the third clock signal being such that (i) a clock pulse of the third clock signal is followed by a clock pulse of the first clock signal, (ii) the clock pulse of the first clock signal is followed by a clock pulse of the second clock signal, and (iii) the clock pulse of the second clock signal is followed by the clock pulse of the third clock signal,
the shift register receiving a shift pulse at one endmost stage thereof and shifting the shift pulse from the one endmost stage thereof to the other endmost stage thereof stage by stage in accordance with each of clock pulses of the first clock signal, the second clock signal, and the third clock signal, sequentially received by the scan signal line driving circuit,
each of the plurality of stages supplying a scan pulse to a corresponding one of a plurality of scan signal lines in accordance with the shift pulse inputted to that stage by the shifting.
